(19) United States
(12) Patent Application Publication
(10) Pub. No.: US 2008/0152393 A1
(43) Pub. Date: Jun. 26, 2008

(54) CARRIER FOR ELECTROPHOTOGRAPHIC DEVELOPER, IMAGE FORMING METHOD, AND PROCESS CARTRIDGE

(76) Inventors: Masashi NAGAYAMA, Machida-shi (JP); Tomio Kondou, Numazu-shi (JP); Shinichiro Yagi, Numazu-shi (JP); Hitoshi Iwatsuki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/958,728

(22) Filed: Dec. 18, 2007

(30) Foreign Application Priority Data
Dec. 20, 2006 (JP) 2006-343255
Mar. 16, 2007 (JP) 2007-067907
Nov. 21, 2007 (JP) 2007-302171

(51) Int. Cl. G03G 15/08

(52) U.S. Cl. 399/254

(57) ABSTRACT

A carrier for electrophotographic developer that comprises a particle of core material and a coating layer that coats the particle of core material, wherein a toner and a carrier are supplied into a developing device where a toner and a carrier being contained, and the surplus developer within the developing device is discharged, a coating layer on at least one of the supplied carrier and the carrier contained in the developing device comprises a white conductive fine particle that includes tin dioxide and indium oxide on a base material.

### BACKGROUND OF THE INVENTION

1. Field of the Invention

The present invention relates to a carrier for electrophotographic developer of two-component developer, an image forming method and a process cartridge.

2. Description of the Related Art

In electrophotographic image forming apparatuses such as copiers and printers, a latent image is formed by exposing a light on a surface of uniformly charged image bearing members, a toner image is formed by developing the latent image, and the toner image is then transferred on transfer members such as recording paper. The transfer member bearing the toner image is passed through a fixing unit, and the toner is fixed on the transfer member by action of heat and/or pressure.

The developing devices, for developing latent images on image bearing members in the image forming apparatuses, are classified into one-component developing type where the developing is carried out by use of a toner that contains a magnetic material and two-component developing type where the developing is carried out by use of a developer that contains a toner and a carrier.

Among these, the developing devices of two-component developing type may exhibit excellent developing property, thus are mainly used in image forming apparatuses currently. The developing devices of two-component developing type have been used recently in color image forming apparatuses for forming full-color or multi-color images in particular, and their needs have been growing still further.

In the image forming apparatuses of two-component developing type, a toner and a carrier are stirred within a developing device, and the toner is imparted a charge from the carrier by action of friction. The toner represents a condition to electrostatically attach to outer surface of the carrier, and the carrier bearing the toner is conveyed to developing region. When a developing bias is applied, the toner detaches from the carrier and electrostatically attaches to a latent image portion of an image bearing member to form a toner image. In order to provide images of two-component developing type with high durability and satisfactory high stability, it is important that a charge amount is stably imparted from the carrier to the toner upon stirring; in this regard, it is important that charge-imparting ability of the carrier is stable even before and after use for prolonged period.

However, toners are consumed during developing processes meanwhile carriers remain within developing containers without consumption in usual developing devices of two-component developing type. Consequently, carriers that are stirred with toners within developing containers degrade along with increasing frequency of the stirring. Specifically, such problematic phenomena occur as resin coating peels from carrier surface and toners adhere to carrier surface, as a result, such problems are induced as resistivity of carrier and charge amount of developer decrease gradually, developing property of developer excessively increases, image density increases, and fog is generated.

Developing devices, having the configuration shown in FIG. 1, are conventionally known as ones that use two-component developers consisting of a toner and a magnetic carrier. The developing device 4 shown in FIG. 1 has a conveying path to supply a developer to a developing roller of a developer-carrying member and a conveying path to stir the developer, separately; the developer is circulated by way of conveying the developer through the two conveying paths oppositely.

In the developing device shown in FIG. 1, the conveying path to supply the developer to the developing roller 5 and the conveying path to collect the developer that is supplied to the developing roller 5 and passes through the developing region are the same. There exists hence a problem that toner concentration in the developer supplied to the developing roller decreases in the conveying direction toward the downstream of the conveying path to supply to the developing roller. When the toner concentration decreases in the developer supplied to the developing roller, the image density decreases at developing step.

Japanese Patent (JP-B) No. 3127594 and Japanese Patent Application Laid-Open (JP-A) No. 11-167260 propose a developing device to solve these problems in which an auger to supply a developer to a developing roller and an auger to collect the developer after developing are provided at different developer conveying paths. The construction of developing devices described in JP-B No. 3127594 and JP-A No. 11-167260 will be explained respectively in the following.

The developing device described in JP-B No. 3127594 is shown in FIG. 2. The developing device 4 shown in FIG. 2 has separately a supplying conveying path 9 to supply a developer from a supplying screw 8 to a developing roller 5 and a collecting conveying path 7 to collect the developer that passes through a developing region along the direction of a collecting screw 6.

The developer after development is conveyed to the collecting conveying path 7 in the developing device 4, thus the developer is far from inclusion into the supplying conveying path 9. Consequently, the toner concentration in the developer may be far from fluctuation within the supplying conveying path 9, and the toner concentration in the developer supplied to the developing roller 5 may also be made constant.

However, there is such a problem that image density is nonuniform and density decreases at developing step since the developer, which being supplied to the collecting conveying path 7, is immediately supplied to the supplying conveying path 9 and thus stirring is insufficient even when toner is supplied and the toner concentration is maintained appropriately. This problem tends to be more noticeable as printing rate of images is higher in which toner concentration of collected developer is lower.

FIG. 3 shows the developing device described in JP-A No. 11-167260. The developing device 4 shown in FIG. 3 separately has a supplying conveying path 9 to supply a developer to a developing roller 5 and a collecting conveying path 7 to collect the developer that passes through a developing region. The developing device 4 is further equipped with a stirring conveying path 10 through which the developer is conveyed to the direction opposite to the supplying conveying path 9 while stirring the developer that is conveyed to the downmost-stream side of the supplying conveying path 9 and the collected developer that is conveyed to the downmost-stream side of the collecting conveying path 7.

The developing unit 4 conveys the developer after development into the collecting conveying path 7 without including into the supplying conveying path 9. Consequently, the toner concentration is free from fluctuation within the supplying conveying path 9 and the toner concentration supplied to the developing roller 5 may be made constant.

Furthermore, the collected developer is supplied to the supplying conveying path 9 after stirring within the stirring conveying path 10 without directly supplying to the supplying conveying path 9, therefore, the developer that passes through the supplying conveying path 9 without being used for development and the collected developer may be supplied to the supplying conveying path 9 after being stirred. As such, a means to prevent the nonuniformity of image density and the decrease of image density at developing step is represented that are the problems in the developing device 4 explained with reference to FIG. 2.

However, insufficient stirring within the stirring conveying path 10 may generate the nonuniformity of image density and the decrease of image density at developing step even in the developing device shown in JP-A No. 1-167260. For example, when the length of the stirring conveying path 10 should be shortened to downsize devices or circulating velocity of the developer should be raised to increase the output, the developer returns to the supplying conveying path 9 before being sufficiently stirred, therefore, stirring is insufficient at the stirring conveying path 10 and electrically uniform condition is unlikely to generate, as a result, image density is unlikely to be uniform or concentration decrease may generate at developing step when highly charged toner is fed disproportionately into the developing portion.

In usual developing devices of two-component development type, toners are consumed during developing processes meanwhile carriers remain within developing containers without consumption. Consequently, carriers that are stirred with toners within developing containers degrade along with increasing the frequency of the stirring. Specifically, such phenomena occur as resin coating peels from carrier surface and toners deposit on carrier surface, as a result, such problems are induced as resistivity of carrier and charge amount of developer decrease gradually, developing property of developer excessively increases, image density increases, and fog is generated.

In order to solve the problem described above, Japanese Patent Application Publication (JP-B) No. 02-21591 discloses a developing device of so-called trickle development type, in which carriers are added along with toners that are consumed for development, and carriers are gradually exchanged within the developing device, thereby fluctuation of the charge amount is suppressed and image density is stabilized.

However, the rate of degraded carriers increases little by little within the developing container along with using for a long period and it is difficult to suppress problems such as increase of image density, even in the developing device disclosed in JP-B No. 02-21591.

JP-A No. 03-145678 discloses that charging ability can be maintained and degradation of image quality can be prevented by use of a developer as the developer that is supplied appropriately to developing devices, in which the developer contains a carrier and a toner and the carrier has a resistivity higher than that of the carrier contained previously within the developing device.

In addition, JP-A No. 11-223960 discloses that charging ability can be maintained and degradation of image quality can be prevented by use of a developer as a supplying developer, in which the developer contains a carrier and a toner, and the carrier impart a higher charge amount to the toner.

However, the carrier amount exchanged within developing devices changes with time while toner consumption varies; thus there arises a problem that image density tends to fluctuate due to variation of resistivity and/or charge amount of the developers within developing devices, in the methods disclosed in JP-A Nos. 03-145678 and 11-223960.

In addition, JP-A No. 08-234550 discloses a method in which plural species of supplying developers are used and the developers are supplied sequentially, and the supplying developers contain toners and carriers having different properties from those filled previously within developing devices.

However, specific gravities are remarkably different indeed between carriers and toners, therefore, it is very difficult to supply sequentially supplying developers into developing devices without intermixing each other within a toner-supplying container as disclosed in JP-A No. 08-234550, where the supplying developers contain one of plural carriers having different physical properties and a toner; in addition, the amount of toners is large relative to carriers in developers, thus the carriers tend to degrade and stable images cannot be formed for a long period.

In addition, when coating amount of silicone coating layer to be coated on the carrier core material is merely increased in order to raise the resistivity of supplying carriers as described in JP-A No. 08-234550, the charge amount of carriers tends to decrease while the resistivity is raised, as a result, there arise such problems as reproducibility of images to be developed is impaired and background smear generates.

It is therefore important that the carrier can stably maintain a charge-imparting ability even under use for a long period in order to take more stable developing properties in the trickle development system.

Particulate carriers, used for two-component developing systems, are typically coated with an adequate resin material (e.g., see JP-A No. 58-108548) or various additives are included into the coating layer (e.g., see JP-B Nos. 01-19584 and 03-628, JP-A No. 06-202381) in order to prevent filming of toners on carrier surface, to form uniform surface of carriers, to prevent surface oxidation, to prevent decrease of moisture sensitivity, to prolong lifetime of developers, to protect photoconductors from flaws or wear by action of carriers, to control charge polarity, to adjust charge amount, etc.

Furthermore, JP-A No. 05-273789 proposes that an additive is deposited on carrier surface; JP-A No. 09-160304 proposes that electrically conductive (hereinafter simply referred to as “conductive”) particles having a size larger than the thickness of coating layer is included into the coating layer.

In addition, JP-A No. 08-6307 proposes to use a carrier-coating material based on a benzoguanamine-n-butyl alcohol-formaldehyde copolymer; JP-B No. 2683624 proposes to use a cross-linked material between a melamine resin and an acrylic resin as a carrier-coating material.

However, there still exist problems in durability and heat-resistance, and also such problems exist as occurrences of toner spent on carrier surface, unstable charge amount therefrom, toner fog, etc.; and it is also necessary to improve environmental resistance.

In addition, resistivity-adjusting agents are conventionally included into carriers to take stable charge property in developers used for two-component development systems. The resistivity-adjusting agents are often carbon black nowadays.

However, when such carriers are used in image forming apparatuses to form color images, it is likely that the carbon black migrates into color images to cause color smear though film scraping from carrier surface or separating the carbon black.

Various methods have been proposed heretofore to suppress these phenomena.

For example, JP-A No. 07-140723 discloses a carrier in which a conductive material (carbon black) exists at surface of core material and no conductive material exists within coating layer.

In addition, JP-A No. 08-179570 discloses a carrier in which a coating layer represents a gradient of carbon black concentration in the thickness direction, the carbon black concentration decreases toward the surface of the coating layer, and no carbon black exists at the surface of the coating layer.

In addition, JP-A No. 08-286429 discloses a carrier having two coating layers, in which an inner coating layer containing conductive carbon is provided at surface of core particles and a surface-coating layer containing a white-type conductive material is disposed thereon.

However, in recent years, there is a significant trend toward speeding up in the image forming apparatuses of electrophotographic systems described above, and stress on developers has been increasing dramatically in association therewith. It is therefore difficult to completely prevent the color smear through migration of carbon black into images even by the proposals of JP-A Nos. 07-140723, 08-179570, and 08-286429.

The present invention has been made in light of the problems in the art; it is an object of the present invention to provide a carrier for electrophotographic developer that can stably maintain charging ability in developing devices, suppress occurrences of carrier deposition at solid image portions even during use for a long period, and adjust electric resistivity to lower thereof; in addition, the objects of the present invention are to provide an electrophotographic developer, an image forming method, an image forming apparatus, and a process cartridge that utilize the carrier.

In addition, the present invention has been made in view of conventional technologies described above; that is, it is an object of the present invention to provide a carrier that can suppress nonuniformity of image density and occurrences of density decrease at developing step even when stirring at a stirring conveying path for developer is weak, in developing devices that employ two-component developing systems and are equipped with a supplying conveying path for developer, a collecting conveying path for developer, and a stirring conveying path for developer, and when the trickle development system is employed, margin can be further taken in charge stability under long-period operation, and no color smear generates on toners even when contacting with toners for a long period in the trickle development system or coating films peel during use for a long period; it is other objects to provide an electrophotographic developer, an image forming method, an image forming apparatus, and a process cartridge that utilize the carrier.

### BRIEF SUMMARY OF THE INVENTION

The present inventors have investigated vigorously to solve the problems described above. That is, the problems described above can be solved by the present invention described below.

<1> A carrier for electrophotographic developer, comprising:

a particle of core material, and

a coating layer that coats the particle of core material,

wherein a toner and a carrier are supplied into a developing device where a toner and a carrier being contained, and the surplus developer within the developing device is discharged,

a coating layer on at least one of the supplied carrier and the carrier contained in the developing device comprises a white conductive fine particle that includes tin dioxide and indium oxide on a base material.

<2> The carrier for electrophotographic developer according to <1>, used for a developing device,

wherein the developing device comprises:

a developer bearing member that rotates while carrying a two-component developer of a magnetic carrier and a toner on its surface and supplies the toner to a latent image on the surface of a latent image bearing member at the site to face with the latent image bearing member to develop,

a developer supplying conveying path that is equipped with a developer supplying conveying member that conveys a developer along an axial direction of the developer bearing member and supplies the developer to the developer bearing member,

a developer collecting conveying path that is equipped with a developer collecting conveying member that conveys the developer, which being collected from on the developer bearing member after passing the site to face the latent image bearing member, along the axial direction of the developer bearing member and also along the same direction with that of the developer supplying conveying member,

a developer stirring conveying path that is equipped with a developer stirring conveying member that receives the surplus developer that is conveyed to the downmost-stream side of the conveying direction of the developer supplying conveying path without being used for development and the collected developer that is collected from the developer bearing member and is conveyed to the downmost-stream side of the conveying direction, and conveys the surplus developer and the collected developer while stirring them along the axial direction of the developer bearing member and also along the reverse direction with that of the developer supplying conveying member, and supplies the developer to the developer supplying conveying path, and

a partition member that partitions the three developer conveying paths of the developer collecting conveying path, the developer supplying conveying path, and the developer stirring conveying path therebetween,

wherein the height of the developer stirring conveying path and the height of the developer collecting conveying path are approximately the same, and the developer supplying conveying path is disposed higher than the other two developer conveying paths, and

the toner and the carrier are supplied into the developer conveying paths and the developer which being surplus in the developing device is discharged.

<3> The carrier for electrophotographic developer according to <1>, wherein the conductive coating layer of the white conductive fine particle is formed of a lower layer that includes tin dioxide and an upper layer that includes tin dioxide and indium oxide.
<4> The carrier for electrophotographic developer according to <1>, wherein the base material for the white conductive fine particle is aluminum oxide.
<5> The carrier for electrophotographic developer according to <1>, wherein the coating layer that coats the particle of core material of the carrier comprises a binder resin and a hard particle, and the ratio D1/h of the particle diameter D1 (μm) of the hard particle to the average thickness “h” (μm) of resin portion in the coating layer satisfies the relation of 1<D1/h<10.
<6> The carrier for electrophotographic developer according to <5>, wherein the hard particle is an alumina particle or an alumina-based particle.
<7> The carrier for electrophotographic developer according to <5>, wherein the white conductive fine particle is used for the hard particle.
<8> The carrier for electrophotographic developer according to <5>, wherein the coating layer that coats the particle of core material of the carrier comprises a second hard particle other than the hard particle, and the ratio D2/h of the particle diameter D2 (μm) of the second hard particle to the average thickness “h” (μm) of resin portion in the coating layer satisfies the relation of 0.001<D2/h<1.
<9> The carrier for electrophotographic developer according to <8>, wherein the second hard particle is a titanium oxide particle or a surface-treated titanium oxide particle.
<10> The carrier for electrophotographic developer according to <1>, wherein the average thickness T (μm) of from the surface of the particle of core material to the surface of the coating layer that coats the particle of core material is within a range of 0.1≦T≦3.0.
<11> The carrier for electrophotographic developer according to <5>, wherein the binder resin comprises at least one of a reaction product between an acrylic resin and an amino resin, and a silicone resin.
<12> An electrophotographic developer, comprising the carrier for electrophotographic developer according to <1> and a toner.
<13> The electrophotographic developer according to <12>, wherein the content of the carrier is from no less than 3% by mass to less than 30% by mass in the supplying developer.
<14> The electrophotographic developer according to <12>, wherein the content of the carrier is from no less than 85% by mass to less than 98% by mass in the developer contained in the developing device.
<15> An image forming method, comprising developing an electrostatic latent image, which being formed on an image bearing member, while a toner and a carrier are supplied into a developing device, where a toner and a carrier being contained, and the surplus developer within the developing device is discharged, and

the carrier for electrophotographic developer according to <1> is used for the carrier.

<16> An image forming apparatus, constructed on the basis of the image forming method according to <15>.
<17> The image forming apparatus according to <16>, wherein a developer supplying device, for supplying the toner and the carrier, comprises a storage container, of which shape to store a supplying developer is easily deformable, and a vacuum pump that sucks in the supplying developer within the storage container and supplies to the developing device.
<18> A process cartridge, comprising:

an image bearing member, and

a developing device that makes an electrostatic latent image formed on an image bearing member into a visible image by use of a developer that contains a toner and a carrier,

wherein the process cartridge is mounted detachably to a body of an image forming apparatus, and supports integratedly the image bearing member and the developing device,

the body of the image forming apparatus comprises a unit configured to supply the toner and the carrier to the developing device and a developer discharging unit configured to discharge the developer that comes to surplus within the developing device, and

the carrier for electrophotographic developer according to <1> is used for the carrier.

In accordance with the carrier for electrophotographic developer according to <1>, a carrier can be provided that can prevent occurrences of color smear on color images, should film scraping occur and coating layers containing conductive fine particles detach from carrier particles, by use of a carrier for electrophotographic developer that comprises a particle of core material and a coating layer that coats the particle of core material, wherein a toner and a carrier are supplied into a developing device where a toner and a carrier being contained, and the surplus developer within the developing device is discharged, a coating layer on at least one of the supplied carrier and the carrier contained in the developing device comprises a white conductive fine particle that includes tin dioxide and indium oxide on a base material.

The carrier for electrophotographic developer according to <2> can provide a carrier for two-component developers, in which the two-component developer is used for developing devices having a developer supplying conveying path, a developer collecting conveying path, and a developer stirring conveying path, as shown in the descriptions below including Examples, the two-component developer can be far from occurrences of nonuniform image density or density decrease at development even under insufficient stirring at the developer stirring conveying path, operating conditions can take an allowance still further in terms of charging stability in the trickle development system for a long period, and the carrier can prevent color smear due of the toner even when contacting with the toner in the trickle development system for a long period or scraping of coating film occurs due to prolonged usage, furthermore an electrophotographic developer is provided, and also an image forming method, an image forming apparatus, and process cartridge are excellently and effectively provided on the basis of the developer. Furthermore, in cases of two-layer coating carrier containing a conductive fine particle, in which the conductive coating layer is formed of a lower layer that includes tin dioxide and an upper layer that includes tin oxide and indium oxide, such a very excellent effect can appear that the change amount of resistance is smaller.

In accordance with the carrier for electrophotographic developer according to <3>, the effect to apply the conductivity can be approximately the same with that of carbon black.

In accordance with the carrier for electrophotographic developer according to <4>, not only the effect of conductive treatment is appropriately exhibited, but also adequate color tone can be easily taken.

In accordance with the carrier for electrophotographic developer according to <5>, the hard particle comes to be convex in relation to the coating layer of the carrier, and the convex portion can mitigate strong impulse, which being impacted by action of frictional contact between a toner and a carrier or between carriers themselves, on the binder resin of the coating layer of carrier, thus the film scraping of the binder resin can be suppressed.

In accordance with the carrier for electrophotographic developer according to <6>, the alumina particle exhibits adequate compatibility with binder resins used for the coating material of carrier, represents excellent dispersibility and adhesive property, and has a very high hardness, thus abrasion and/or crack hardly occur against stress, and the effect to protect the coating layer and the effect to scrape the spent material are exerted for a long period.

In accordance with the carrier for electrophotographic developer according to <7>, other particles are unnecessary and also the step to pour the hard particle is deleted, thus the production cost can be decreased.

In accordance with the carrier for electrophotographic developer according to <8>, the second particle is made smaller than the average thickness of the coating layer of the carrier, thereby the second particle can be dispersed and enveloped within the coating layer; consequently, the strength of the coating layer can be increased on average.

In accordance with the carrier for electrophotographic developer according to <9>, the titanium oxide particle or the surface-treated titanium oxide particle has a reasonable hardness, exhibits adequate compatibility with binder resins used for the coating material of carrier, and represents excellent dispersibility and adhesive property.

In accordance with the carrier for electrophotographic developer according to <10>, the core material of the carrier can be prevented from scraping of the coating layer to expose thereof due to its unduly thin total thickness and also from carrier adhesion derived by lower magnetization of the carrier due to its unduly large thickness.

In accordance with the carrier for electrophotographic developer according to <11>, the coating layer that coats the core material of the carrier can exhibit higher mechanical durability and the carrier can be provided with an appropriate capability to apply an electrical charge.

In accordance with the electrophotographic developer according to <12>, color smear can be prevented from occurring on color images and carrier adhesion can be prevented from occurring at solid image portions even under usage for a long period, since the inventive carrier is employed.

In accordance with the electrophotographic developer according to <13>, the developer can be stably supplied with the carrier of a sufficient amount to exhibit the effect.

In accordance with the electrophotographic developer according to <14>, the charge amount can be controlled into an appropriate range, thus such problems can be prevented as decrease of image density because of higher charge amounts and background smear because of lower charge amounts. Such phenomena can also prevented as shorter life of coating layers that coat the core material of carrier, which being derived from the fact that unduly high mass rates of carrier lead to higher collision possibility of carriers themselves.

In accordance with the image forming method according to <15> and the image forming apparatus according to <16>, images can be formed along with suppressing color smear on color images and also suppressing carrier adhesion at solid image portions even under usage for a long period.

In accordance with the image forming apparatus according to <17>, the toner can be supplied in a condition that the toner amount supplied by the supplying device is stable and the amount of the toner remaining within the developer containing member is reduced, in addition to the effects of the image forming apparatus described above.

In accordance with the process cartridge according to <18>, images can be formed along with suppressing color smear on color images and also suppressing carrier adhesion at solid image portions even under usage for a long period.

### BRIEF DESCRIPTION OF THE SEVERAL VIEWS OF THE DRAWINGS

FIG. 1 is a schematic view that shows the construction of a conventional developing device.

FIG. 2 is a schematic view that shows the construction of the developing device described in JP-B No. 3127594.

FIG. 3 is a schematic view that shows the construction of the developing device described in JP-A No. 11-167260.

FIG. 4 is an illustrative view that shows a coating layer of the inventive carrier for electrographic developer.

FIG. 5 is a perspective view of a resistivity-measuring cell to measure the resistivity of the inventive carrier for electrographic developer.

FIG. 6 is a schematic view that shows the construction of a copier of an inventive embodiment.

FIG. 7 is a schematic view that shows the construction of a developing device and a photoconductor.

FIG. 8 is a perspective sectional view that explains the flow of developer.

FIG. 9 is a pattern diagram that shows the flow of developer in a developing device.

FIG. 10 is a schematic view that shows the construction of the image forming apparatus of an inventive preferable embodiment.

FIG. 11 is a schematic view that shows the configuration around the developing portion of the developing device of an inventive preferable embodiment.

FIG. 12 is a schematic view that shows the construction of the developer-supplying portion of an inventive preferable embodiment.

FIG. 13A is an outline view that shows schematically the construction of the nozzle equipped in the developer supplier of an inventive preferable embodiment.

FIG. 13B is a cross-section view in axial direction of FIG. 13A.

FIG. 13C is a cross-section view at A-A in FIG. 13B.

FIG. 14 is a cross-section view that shows schematically the construction of the screw pump of an inventive preferable embodiment.

FIG. 15 is a perspective view that shows the condition where a developer is filled into the developer-containing member of an inventive preferable embodiment.

FIG. 16 is a front view that shows the condition where a developer is discharged and decreased within the developer-containing member of an inventive preferable embodiment.

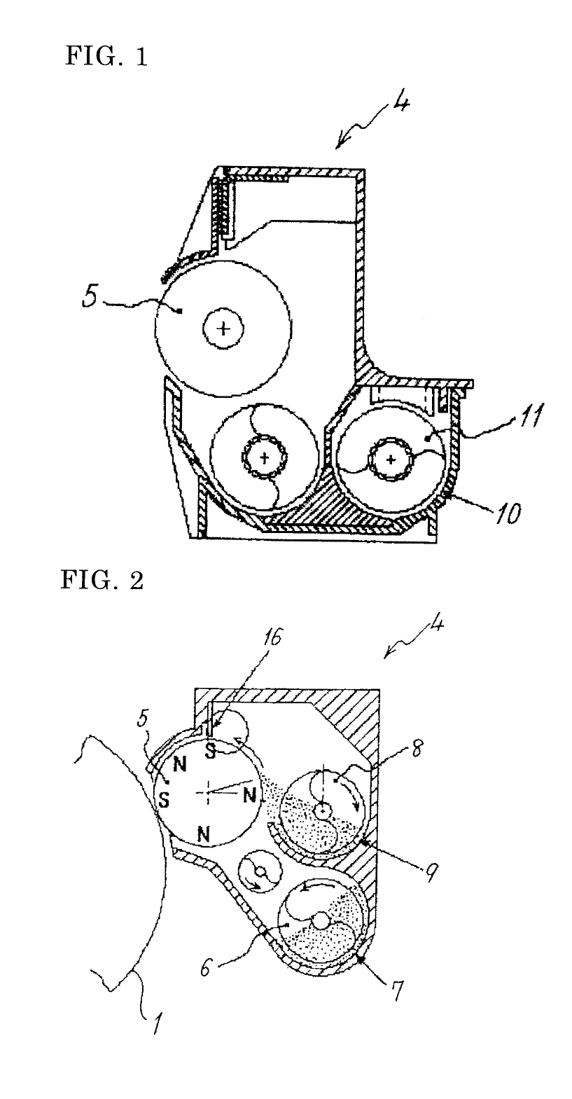

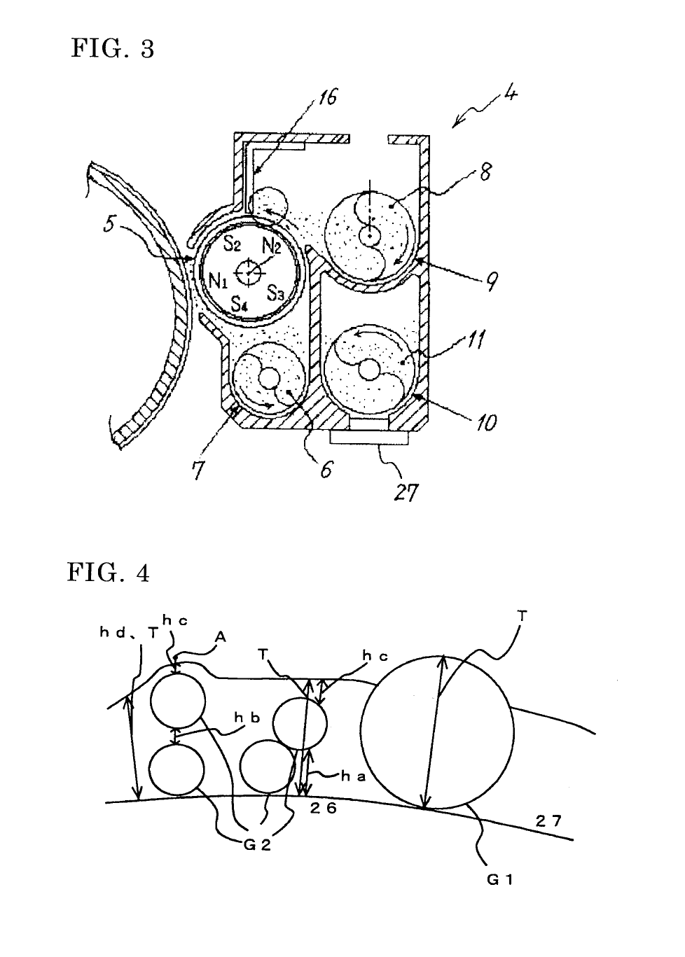

### DETAILED DESCRIPTION OF THE INVENTION

The present invention will be explained in more detail with respect to inventive embodiments with reference to figures in the following.

The present invention is a carrier for electrophotographic developer that is comprised of particles of core material and a coating layer that coats the particles of core material; a toner and a carrier are supplied to a developing device in which a toner and a carrier are contained and surplus developer within the developing device is discharged; coating layer on at least one of the supplied carrier and the carrier contained in the developing device comprises a white conductive fine particle including tin dioxide and indium oxide on a base material; thereby, occurrence of color smear can be prevented if by chance film on the carrier is peeled and the coating layer including the conductive particles is separated from carrier particles in the developing device, the conveying paths, or the supplying device.

The present inventors have investigated vigorously to solve the problems described above. As a result, it has been found that when the developing device of two-component development type is equipped with a supplying conveying path for developer, a collecting conveying path for developer, and a stirring conveying path for developer, nonuniformity of image density and density decrease are unlikely to occur at developing step; development is carried out while a toner and a carrier are supplied to the developing device and also surplus developer within the developing device is discharged, thereby fluctuation of charge amount is suppressed and image density is stabilized; inclusion of white conductive fine particle having a highly conductive coating layer derived from tin dioxide and indium oxide into the coating layer of the carrier, used in the developing method, can represent local electric leak points, thus such advantages can be taken as electric charge easily moves within the developer, the distribution of charge amount tends to be uniform when the developer passed through the supplying conveying path of developer and the developer conveyed from the collecting conveying path of developer are mixed, and prevention of nonuniformity of image density and density decrease is promoted still more, and at the same time such an advantage can be taken as occurrence of color smear can be prevented if by chance film on the carrier is peeled and the coating layer including the conductive particles is separated from carrier particles in the developing device, the conveying paths, or supplying device, since the conductive particles are not colored conductive material like carbon. In cases of trickle development system, it is very preferable that no color smear generates even when coating film of carriers is peeled and separated since the supplying toner is stored in a condition to contact with a carrier.

That is, the present inventors have found that when the white conductive fine particle having a highly conductive coating layer derived from tin dioxide and indium oxide is included into the coating layer on carrier, the effect is further promoted to uniformize the charge amount of developer by use of the developing device equipped with a supplying conveying path for developer, a collecting conveying path for developer, and a stirring conveying path for developer, and at the same time the effect that no color smear generates is taken absolutely in developing devices, and also in supplying devices and conveying devices even in cases of supplying developers that is used in trickle development systems.

Should the coating layer including the conductive fine particle is separated from the carrier particles, there arises no problem in terms of color smear when the color of the conductive fine particle does not adversely affect the coloring of toner. The present inventors have investigated vigorously and concluded that when the conductive fine particle is white, no adverse effect is induced on the coloring of toner provided that the conductive fine particle is detached from the resin coating layer on carrier. Specifically, powder color tone of the conductive fine particle is such that L-value is 70 or more, more preferably 80 or more, particularly preferably 85 or more, b-value is −10 or more and 10 or less, more preferably −5 or more and 5 or less, particularly preferably −1 or more and 3 or less, then the conductive fine particle can be used without adverse effect on coloring of toner.

When the L-value of the powder color tone is less than 70, insufficient whiteness degree may adversely affect on the coloring of toner. When the b-value is less than −10 or more than 10, color smear may generate when fixed with a toner because of higher color saturation.

The method to measure the powder color tone is as follows in the present invention.

A sample of conductive fine particle is weighed in an amount of 6 grams by use of an even balance. A sheet of white paper is laid on a molding die, a stainless ring is placed, and the weighed sample is inserted and a press tag is disposed thereon. The sample is pressed by a compact automatic pressing machine, then L-value and b-value are read by use of a color-difference meter adjusted to standard based on a standard version. The color-difference meter (calorimeter) in use and the stainless ring were shown below.

Colorimeter: by Nippon Denshoku Industries Co., Z-10018P or a meter having equivalent or higher capability

Stainless ring: inner diameter 40 mm Φ, height 18 mm

In order to make a particle conductive, a conductive coating layer is formed on the surface of the particle of base material. When such a construction is provided, in particular, that tin dioxide layer is disposed on the surface of the particle of base material and a conductive coating layer formed of tin dioxide and indium oxide is disposed on the tin dioxide layer, the electric conductivity may be equivalent with that of carbon black.

In this regard, even when a conductive coating layer formed of tin dioxide and indium oxide is disposed directly on the surface of base material, appropriate electric conductivity may not be obtained since electric influence of the particle of base material is significant. Furthermore, even when a mixture liquid of tin dioxide hydrate and indium oxide hydrate is coated directly on the base material, a problem of quality may occur since it is difficult to coat uniformly the surface of base material.

When the surface of the particle of base material is coated with a coating material selected from conventional ones such as aluminum oxide, zinc oxide, and zirconium oxide, and then the particle of base material is coated with a coating material such as mixture liquid of tin dioxide hydrate and indium oxide hydrate, a uniform conductive coating layer may be formed. When the coating material is used as the lower layer, it is likely that proper conductivity is unobtainable or fluctuation is significant due to the electrical influence of the coating material. It has hence been found that when the lower layer is formed using tin dioxide as the coating material, conductive coating layer of upper layer can be fixed uniformly and firmly, and appropriate conductivity can be taken without electrical adverse effect from the lower layer. A small amount of indium oxide may be included into the lower layer as long as the amount is of the level not to impair the effect of the particle.

The base material of the conductive fine particle may be aluminum oxide, titanium dioxide, zinc oxide, silicon dioxide, barium sulfate, or zirconium oxide; these may be used alone or in combination to provide a considerable effect to improve the conductivity. The reason is believed that the compatibility is adequate with the surface of the particle and thus the effect of conductive treatment is appropriately exhibited. In particular, aluminum oxide and titanium dioxide are possible to satisfy the conditions of color tone described above; among others, preferable color tone is easily taken from aluminum oxide. In this regard, the present invention is not defined by the particle described above, and the other particles may be available as long as able to exhibit adequate effects. When titanium dioxide is used as the base material, the titanium dioxide may be rutile, anatase, or other structures.

The method to produce the conductive fine particle suited to the present invention may be as follows; but these are exemplary and to which the method to produce the conductive fine particle is not defined in the present invention.

The method to form a film of lower layer by use of tin dioxide hydrate may be, for example, the method in which a solution of tin salt or tin acid salt is added to an aqueous dispersion of white inorganic pigment and then an alkaline or an acid is added, the method in which tin salt or tin acid salt and an alkaline or an acid are separately added in parallel to coat-treat, etc. In order to coat-treat uniformly the surface of the particle of white inorganic pigment by use of hydrous tin oxide, the latter method of parallel addition is more preferable; in this method, the aqueous dispersion is preferably warmed and maintained at 50° C. to 100° C. In addition, the range of pH is adjusted between 2 and 9 when tin salt or tin acid salt and an alkaline or an acid are separately added in parallel. Since the isoelectric point of tin dioxide hydrate is pH=5.5, it is important that pH is maintained in a range of preferably 2 to 5 or 6 to 9, thereby water-addition reaction product of tin can be deposited or fixed uniformly on the surface of the particle of white inorganic pigment.

Available tin salts are exemplified by tin chloride, tin sulfate, tin nitrate, etc. Available tin acid salts are exemplified by sodium tin oxide, potassium tin oxide, etc.

Available alkalines are exemplified by sodium hydroxide, potassium hydroxide, sodium carbonate, potassium carbonate, ammonium carbonate, aqueous ammonia, ammonia gas, etc.; available acids are exemplified by hydrochloric acid, sulfuric acid, nitric acid, acetic acid, etc.

The coating amount of tin dioxide hydrate is 0.5% to 50% by mass expressed as SnO₂ based on the particle of base material, preferably 1.5% to 40% by mass. When the coating amount is less than 0.5% by mass, the coating condition of indium oxide hydrate containing tin oxide coated thereon is likely to be nonuniform and also volume resistivity of the powder is likely to be high by influence of the particle of base material. When the coating amount is larger than 50% by mass, the amount of tin oxide hydrate, which being out of close contact with the surface of the particle of base material, increases and the coating tends to be nonuniform.

The method to form the upper layer coating of indium oxide hydrate containing tin dioxide will be discussed in the following. It is also preferable in this method that a mixture solution of tin salt and indium salt is separately added in parallel with an alkaline to form the coating film in order to prevent to dissolve the coating film of the tin dioxide hydrate that is coated previously. It is preferable in the method that the aqueous dispersion is warmed at 50° C. to 100° C. It is also important that when a mixture solution and an alkaline are added in parallel, pH is adjusted between 2 to 9, preferably pH is maintained between 2 to 5 or 6 to 9, thereby water-addition reaction product of tin and indium can be deposited or fixed uniformly.

Available raw materials of conductive tin are exemplified by tin chloride, tin sulfate, tin nitrate, etc. Available raw materials of indium are exemplified by indium chloride, indium sulfate, etc.

The amount of tin dioxide is 0.1% to 20% by mass expressed as SnO₂ based on In₂O₃, preferably 2.5% to 15% by mass; excessively small or large amount thereof leads possibly to undesirable conductivity.

The amount of indium oxide is 5% to 200% by mass expressed as In₂O₃ based on the inorganic pigment of base material, preferably 8% to 150% by mass; excessively small amount thereof possibly leads to undesirable conductivity and excessively large amount thereof possibly leads to little increase of conductivity and unfavorable higher cost.

The term “conductive” powder as used herein means that the powder has a volume resistivity value of 1 to 500 ohm·cm. As described in Examples later, the present invention may bring about white conductive powder having a very excellent conductivity similarly as antimony-containing products such as of no higher than 100 ohm·cm, and no higher than 10 ohm·cm in some cases.

When the powder is heat-treated, the condition is preferably in non-oxidative atmosphere at 350° C. to 750° C.; the volume resistivity of the powder may be lowered into 1/100 to 1/1000 compared to those heat-treated in air.

The non-oxidative atmosphere may be made using inactive gas. Available inactive gas is exemplified by nitrogen, helium, argon, carbon dioxide gases, etc. It is industrially advantageous in view of cost that the teat-treatment is carried out while injecting nitrogen gas thereby the resulting properties may be stable.

The heating temperature is 350° C. to 750° C., preferably 400° C. to 700° C., it is difficult to take desirable conductivity when the temperature is higher or lower than this range. Excessively short heating period may lead to an insignificant effect and a large effect is undesirable from an excessively long period, thus the appropriate heating period is about 15 minutes to 4 hours, preferably about 1 to 2 hours.

In addition, when the specific resistance of powder is above 200 ohm·cm for the conductive fine particle, the capacity of the conductive fine particle to decrease the resistance is poor, thus the conductive fine particle is necessary for a large amount to make the resistivity of the carrier into an appropriate value. The rate of the particle, occupying at the surface the carrier, is excessively large compared to the rate of the binder resin; therefore, the rate of the binder resin, which providing charge-generating sites, comes to be insufficient and sufficient charging capacity cannot be exerted. Furthermore, the amount of particle is excessively large compared to the amount of binder resin; therefore, the capacity to sustain the particle by the binder resin comes to be insufficient and the particle comes to easily separate, which unfavorably resulting in higher fluctuation of charge amount and resistance and insufficient durability.

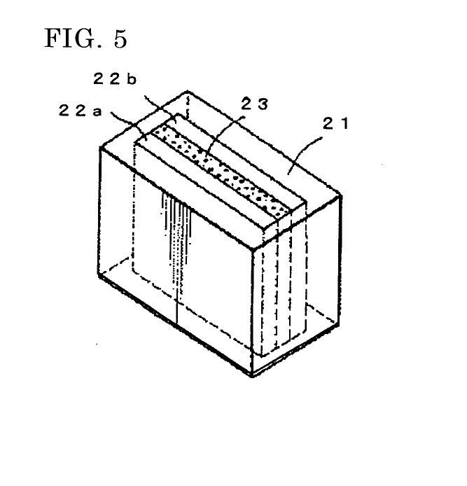

FIG. 4 is an illustrative view that shows a coating layer of the carrier used in an inventive embodiment.

The carrier used in the present invention has a core material 26 and a coating layer 27 that coats the core material 26 as shown in FIG. 4, and the coating layer 27 contains at least a binder resin and a hard particle (hereinafter referred to as “first particle G1”); it is preferred that the particle diameter D1 (μm) satisfies such a relation of D1/h with average thickness “h” (μm) of resin portion in the coating layer 27 as 1<D1/h<10. It is preferred in other words that the ratio D1/h is larger than 1 and smaller than 10.

The layer that coats the core material 26 may have other layers in addition to the coating layer 27. The coating layer 27 may also contain other ingredients in addition to the binder resin, the first particle G1, and the second particle G2 as required.

The average thickness “h” of the resin portion of the coating layer 27 expresses the thickness of the film that exists perpendicularly to the surface of the core material 26, and indicates the average thickness of the resin portion of the thickness from the surface of the core material 26 to the surface of the coating layer 27 except for particle portion.

As shown in FIG. 4, the thickness of the resin portion of the coating layer 27 is comprised of the thickness ha of the resin portion that exists between the surface of the core material 26 and a particle, the thickness hb of the resin portion that exists between particles, the thickness hc of the resin portion that exists over a particle, and the thickness hd of the resin portion that exists over the core material 26.

The average thickness “h” of the resin portion of the coating layer 27 can be measured, for example, through observing cross section of the carrier by use of a transmission electron microscope (TEM). Specifically, the thickness of resin portions of the coating layer 27 (thickness ha of the resin portion that exists between the surface of the core material and a particle, thickness hb of the resin portion that exists between particles, thickness hc of the resin portion that exists over a particle, and thickness hd of the resin portion that exists over the core material) are measured along the surface of the carrier in a pitch of 0.2 μm by use of a TEM to take 50 measured values, then the values are averaged to obtain the average thickness “h” of the resin portion of the coating layer 27.

Specific calculation method is such that the measured values taken by the method described above are totalized, and the resulting value is divided by the number of the measured values to obtain the average thickness “h” of the resin portion of the coating layer 27. The number of the measured values is counted as one per the thickness ha of the resin portion that exists between the surface of the core material 26 and a particle, the thickness hb of the resin portion that exists between particles, the thickness hc of the resin portion that exists over a particle, and the thickness hd of the resin portion that exists over the core material 26, respectively.

For example, hb and hc exist at the measuring point A of FIG. 4, thus the number of measured values is two at the measuring point A.

When plural measured values (e.g., ha and hc) are taken at the last measuring site in the measuring method described above in a course to measure 50 values as the measured values of the resin portion of the coating layer 27, the total vale of the measured values is divided by the number of the measured values, i.e. 49+the number of the measured values at the last measuring site, to obtain the average thickness “h” of the resin portion of the coating layer 27.

The particle diameter D1 (μm) of the hard particle (hereinafter referred to as “first particle G1”), which being contained in the coating layer 27, satisfies such a relation with the average thickness “h” (μm) of resin portion in the coating layer 27 as 1<D1/h<10, more preferably 1<D1/h<5.

When the particle diameter D1 of the first particle G1 and the average thickness “h” of the resin portion in the coating layer 27 satisfy the relational equation described above, the first particle G1 comes to be convex in relation to the coating layer 27 of carrier. The convex portion may mitigate strong impulse, which being impacted by action of frictional contact between a toner and a carrier or between carriers themselves, on the binder resin of the coating layer 27 of carrier, when the developer is stirred so as to cause frictional charge. Consequently, film scraping of the binder resin, which is the sites to generate charging, of the coating layer 27 of carrier may be suppressed.

Furthermore, a cleaning effect can be taken in a way that the particles, existing in a convex condition in relation to the surface of the coating layer 27 described above, scrape off the spent ingredient of toner deposited on the carrier surface through frictional contact between carriers. Consequently, the phenomenon of toner spent may be effectively prevented to occur.

When D1/h is no more than 1, the effect of the first particle G1, added into the coating layer 27, may be insufficient since the first particle is buried into the binder resin. When D1/h is no less than 10, the first particle G1 may easily separate from the surface of carrier particle since the contact area is small between the first particle G1 and the binder resin and the binding force of the first particle G1 is insufficient against the carrier particle.

It is preferred that the coating layer 27 contains a second hard fine particle (hereinafter referred to as “second particle G2”) in order to provide the coating layer with an adequate strength on average; the particle diameter D2 (μm) of the second particle preferably satisfies such a relation with the average thickness “h” (μm) of resin portion in the coating layer 27 as 0.001<D2/h<1, more preferably 0.01<D2/h<0.5.

When the value of D2/h is no less than 1, it is difficult to exert the effect to increase the strength of the coating layer on average through dispersing the second particle G2 since the particle diameter of the second particle G2 is excessively large in relation to the thickness of the coating layer 27. When the value of D2/h is no more than 0.001, it is also difficult to exert the effect since the particle diameter of the second particle G2 is excessively large in relation to the thickness of the coating layer 27.

When the particle diameter D2 of the second particle G2 is smaller than the average thickness of the coating layer 27, the second particle G2 can be dispersed and enveloped within the coating layer 27; consequently, the strength of the coating layer can be increased on average.

The volume resistivity value of the second particle G2 is preferably no more than 1.0×10¹² ohm·cm, more preferably no more than 1.0×10¹⁰ ohm·cm, still more preferably no more than 1.0×10⁸ ohm·cm. When the volume resistivity of the second particle G2 is lowered as no more than 1.0×10¹² ohm·cm, the charge-imparting capacity of the coating layer 27 may be adjusted to an adequate low level and the resulting image density may be enhanced.

The volume resistivity of the conductive fine particle, the first particle G1, and the second particles G2 may be measured in the present invention as follows, for example.

A sample is placed into a cylindrical pipe of vinyl chloride of inner diameter 1 inch, and the upper and lower sides of the sample are sandwiched by electrodes. A pressure of 15 kg/cm² is applied to the electrodes for one minute using a press machine. Resistivity (r) is measured by means of an LCR meter under the pressing condition. From the resistivity value, the volume resistivity can be obtained through calculation based on Equation (1) below.

Volume resistivity(ohm·cm)=(2.54/2)²×([π/H]×r) (1)

in which, H represents a thickness of the sample, “r” represents a resistivity value (ohm) of the sample, in the Equation (1).

It is preferred that the average thickness T (μm) of from the surface of the core material 26 to the surface of the coating layer 27 satisfies the relation of 0.1≦T≦3.0, more preferably 0.1≦T≦2.0.

When the average thickness T of from the surface of the core material 26 to the surface of the coating layer 27 is less than 0.1 μm, such a phenomenon is likely to occur as the coating layer 10 is scraped to expose the core material 26 of carrier under running with time since the total thickness of the coating layer 27 as the film that covers the core material 26 of carrier is excessively thin, thus the durability of the carrier is poor.

When the average thickness T of from the surface of the core material 26 to the surface of the coating layer 27 is above 3.0 μm, the magnetization of the carrier is likely to be low since the film thickness on the surface of the core material 26 is excessively large, possibly resulting in carrier adhesion.

The average thickness “h” (μm) of resin portion of the coating layer 27 is preferably 0.04 to 2 μm, more preferably 0.04 to 1 μm.

The volume average particle diameter D1 of the first particle G1 is preferably 0.05 to 3 μm, more preferably 0.05 to 1 μm.

The particle diameter D2 of the second particle G2 is preferably 0.005 to 1 μm, more preferably 0.01 to 0.2 μm.

The thickness T of from the surface of the core material 26 to the surface of the coating layer 27 represents, as shown in FIG. 4, thicknesses of from the surface of the core material 26 to the surface of the coating layer 27 at various sites of the surface of carrier other than the average thickness “h” of resin portion of the coating layer 27 described above.

When the particle diameter of the particle added into the coating layer 27 is larger than the thickness of resin portion of the coating layer 27, as shown in FIG. 4, the particle diameter of the particle corresponds to the thickness T of from the surface of the core material 26 to the surface of the coating layer 27.

The average thickness T of from the surface of the core material 26 to the surface of the coating layer 27 can be obtained, for example, through observing cross section of the carrier by use of a transmission electron microscope (TEM) and the thickness of from the surface of the core material 26 to the surface of the coating layer 27 is measured along the surface of the carrier in a pitch of 0.2 μm by use of a TEM to take 50 measured values, then the measured values are averaged.

The first particle G1 is exemplified by alumina, silica, titania, zinc oxide particles, etc., among these, alumina particle is preferable in particular since the alumina particle exhibits adequate compatibility with binder resins used for the coating material of carrier, represents excellent dispersibility and adhesive property, and has a very high hardness, thus abrasion and/or crack hardly occur against stress within the developing device 10, and the effect to protect the coating layer and the effect to scrape the spent material are exerted for a long period.

The alumina particle is preferably one having a particle diameter of no more than 5 μm; the alumina particle may be one non-surface-treated or one surface-treated into hydrophobicity.

The silica may be one used for toners or others, and may be one non-surface-treated or one surface-treated into hydrophobicity. The conductive fine particle described above may be used as the first particle G1.

The content of the first particle G1 is preferably 10% to 80% by mass in the coating layer 27, more preferably 20% to 60% by mass.

When the content of the first particle G1 is below 10% by mass in the coating layer 27, the rate of the first particle G1 is excessively small at the surface of the carrier particle compared to the binder resin, thus the effect to mitigate the contact with a strong impulse against the binder resin is poor, resulting possibly in insufficient durability.

On the other hand, when the content is above 80% by mass, the rate of the first particle G1 is excessively large at the surface of the carrier particle compared to the binder resin, therefore, the rate of the binder resin, which providing charge-generating sites, comes to be insufficient and sufficient charging capacity may not be exerted. Furthermore, the amount of the first particle G1 is excessively large compared to the amount of binder resin; therefore, the capacity to sustain the first particle G1 by the binder resin comes to be insufficient and the first particle G1 comes to easily separate, which possibly resulting in higher fluctuation of charge amount and resistance and insufficient durability.

The content (% by mass) of the first particle G1 in the coating layer 27 is expressed by Equation (2) below.

Content of first particle G1(% by mass)=[content of first particle G1(by mass)/total mass of materials in coating layer 27(first particle G1+second particle G2+binder resin+other ingredients)]×100 (2)

The second particle G2 is preferably at least a particle selected from titanium oxide, zinc oxide, tin oxide, surface-treated titanium oxide, surface-treated zinc oxide, and surface-treated tin oxide.

These particles have a reasonable hardness, exhibit adequate compatibility with binder resins used for the coating material of carrier, and represent excellent dispersibility and adhesive property; in particular, titanium oxide and surface-treated titanium oxide are preferable for the second particle G2.

When the base substance of the particle is other than those described above, a proper effect may be obtained on the similar grounds provided that the dispersibility is enhanced by surface-treating the particle surface into hydrophobicity etc. or the particle diameter and the volume resistivity are made into the ranges described above by surface-treatment such as conductive treatment.

The content of the second particle G2 is preferably 2% to 50% by mass in the coating layer 27, more preferably 2% to 30% by mass.

The larger is the content of the second particle G2 in the coating layer 27, the more significant is the effect to enhance the strength; however, when the content of the second particle G2 is above 50% by mass, the dispersibility of the second particle G2 is deteriorated remarkably within the coating layer 27. When the dispersed condition of the particle is deteriorated, a part of the second particle G2 agglomerates within the coating layer 27, thus the effect of the second particle G2 tends to be reduced on average.

On the other hand, when the content of the second particle G2 is below 2% by mass in the coating layer 27, excessively low content may lead to insufficient effect to add the second particle G2.

The content of the second particle G2 in the coating layer 27 is expressed by Equation (3) below.

Content of second particle G2(% by mass)=[content of second particle G2(by mass)/total mass of materials in coating layer 27(first particle G1+second particle G2+binder resin+other ingredients)]×100 (3)

The binder resin used for the coating layer 27 of carrier particle is preferably exemplified by reaction products between acrylic resins and amino resins, and silicone resins.

The reaction products between acrylic resins and amino resins, which may be properly selected depending on the application, are preferably cross-linked reaction products between acrylic resins and amino resins.

The acrylic resin, which may be properly selected depending on the application, preferably has a glass transition temperature Tg of 20° C. to 100° C., more preferably 25° C. to 80° C. When the glass transition temperature Tg of the acrylic resin is within the range, the acrylic resin may have an adequate elasticity, thus the impulse can be absorbed when the binder resin is contacted involving strong impulse due to friction between a toner and a carrier or between carriers themselves, when the developer is stirred so as to cause frictional charge, which making possible to maintain the coating layer without breakage.

When the glass transition temperature Tg of the acrylic resin is below 20° C., the developer may be unusable due to improper storage stability since the binder resin causes blocking even at normal temperature. On the other hand, when the glass transition temperature Tg is above 100° C., the binder resin is hard and brittleness is unduly high, thus the impulse cannot be absorbed, the brittleness results in scraping of the binder resin, and the particle cannot be sustained and may easily detach.

The amino resin may be properly selected from conventional amino resins depending on the application; for example, when guanamine or melamine is used, the capacity to impart the charge amount may be significantly enhanced.

The silicone resin may be properly selected from conventional silicone resins depending on the application; examples thereof include straight silicone resins having exclusively an organosiloxane bond, and silicone resins modified with alkyd resins, polyester resins, epoxy resins, acrylic resins, or urethane resins.

The silicone resin may be commercially available ones; examples of the straight silicone resins include KR271, KR255, KR152 (by Shin-Etsu Chemical Co., Ltd.), SR2400, SR2406, and SR2410 (by Dow Corning Toray Silicone Co.).

The modified silicone resins are exemplified by KR206 (alkyd modified), KR5208 (acryl modified), ES1001N (epoxy modified), KR305 (urethane modified) (by Shin-Etsu Chemical Co., Ltd.); SR2115 (epoxy modified), and SR2110 (alkyd modified) (by Dow Corning Toray Silicone Co.). The silicone resin may be used alone or in combination with an ingredient of cross-linking reaction, an ingredient to adjust charge amount, etc.

The binder resin used for the coating layer 27 of carrier particle may be, in addition to the resins described above, those conventionally employed for coating resins for carriers as required; examples of the binder resin include polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, vinylidene fluoride-vinyl fluoride copolymers, and fluoro terpolymers such as of tetrafluoroethylene and vinylidene fluoride and non-fluoride monomers. These may be used alone or in combination of two or more.

The coating layer 27 may be formed, for example, by way of dispersing or dissolving the first particle G1, the second particle G2, the binder resin, etc. into a solvent to prepare a coating liquid, then coating the coating liquid uniformly on the surface of the core material 26 by a conventional coating process, followed by drying and baking. The coating process is exemplified by immersing processes, tumbling fluidized bed processes, spray processes, etc.

The solvent may be properly selected depending on the application; examples thereof include toluene, xylene, methylethylketone, methylisobutylketone, cellosolve, butylacetate, and butyl cellosolve.

The baking may be of external heating systems or internal heating systems without particular limitations; for example, the baking may be carried out using static electric furnaces, fluidized electric furnaces, rotary electric furnaces, burner furnaces, or microwave systems.

The volume average particle diameter of the core material 26 of the carrier used in inventive embodiments is not limited specifically; preferably, the volume average particle diameter is no less than 20 μm in view of carrier deposition onto the image bearing member 1 and prevention of carrier scattering, preferably no more than 100 μm in view of prevention of abnormal images such as carrier streak and prevention of degradation of image quality; in particular, the volume average particle diameter of 20 to 60 μm may respond to the demand of high image quality in recent years.

The core material 26 may be properly selected from electrophotographic two-component carriers conventionally used in the art; preferable examples thereof include ferrites, magnetites, iron, and nickel. When ferrites are used, for example, Mn ferrites, Mn—Mg ferrites, and Mn—Mg—Sr ferrites are advantageously employed other than conventional Cu—Zn ferrites from the view point of environmental influence discussed considerably in recent years.

Specific preferable examples are MFL-35S, MFL-35HS (by Powder Tech Co.), DFC-400M, DFC-410M, SM-350NV (by Dowa Iron Powder Industry, Co.).

The resistivity of the inventive carrier is preferably 1×10¹¹ to 1×10¹⁶ ohm·cm, more preferably 1×10¹² to 1×10¹⁴ ohm·cm.

When the resistivity of the inventive carrier is less than 1×10¹¹ ohm·cm, carrier adhesion is likely to generate through inducing charge on the carrier in cases that developing gap (most close distance between photoconductors and developing sleeves) comes to narrow. When linear velocity of photoconductors and linear velocity of developing sleeves are large, degradation tends to appear, and which is remarkable when AC bias is applied. Usually the carrier for developing color toners is of lower resistivity in order to take sufficient deposited amount of toners.

The carrier, having a resistivity within the range, may bring about sufficient image density when used under an adequate charge amount of toner.

When the resistivity is above 1×10¹⁶ ohm·cm, electric charge having opposite polarity with the toner tends to accumulate and the carrier adhesion easily occurs due to electrically charged toner.

The resistivity of carrier can be measured in accordance with the following process.

A carrier 23 is filled in a cell 21 of a fluorine resin container that houses electrodes 22a, 22b of surface area 2 cm×4 cm with distance 2 mm between the electrodes, as shown in FIG. 5, then a DC voltage of 100 volts is applied between the electrodes, and a DC resistance is measured directly by use of a high resistance meter 4329A (4329A+LJK 5HVLVWDQFH OHWHU; by Yokokawa Hewlett-Packard Co.).

The level to fill the carrier, when measuring the resistance, is created in a way that the carrier is filled into the cell to overflow therein, the cell is tapped as a whole 20 times, then the upper face of the cell is flatly scraped off one time along the upper end of the cell using a non-magnetic flat spatula; when filling, pressure is unnecessary. The resistivity of the carrier can be arranged by controlling the amount of the conductive fine particle or film thickness of the resin-coating layer.

An embodiment of a tandem-type color laser copier (hereinafter referred to simply as “copier”) having plural photoconductors disposed in parallel will be explained as an image forming apparatus in accordance with the present invention.

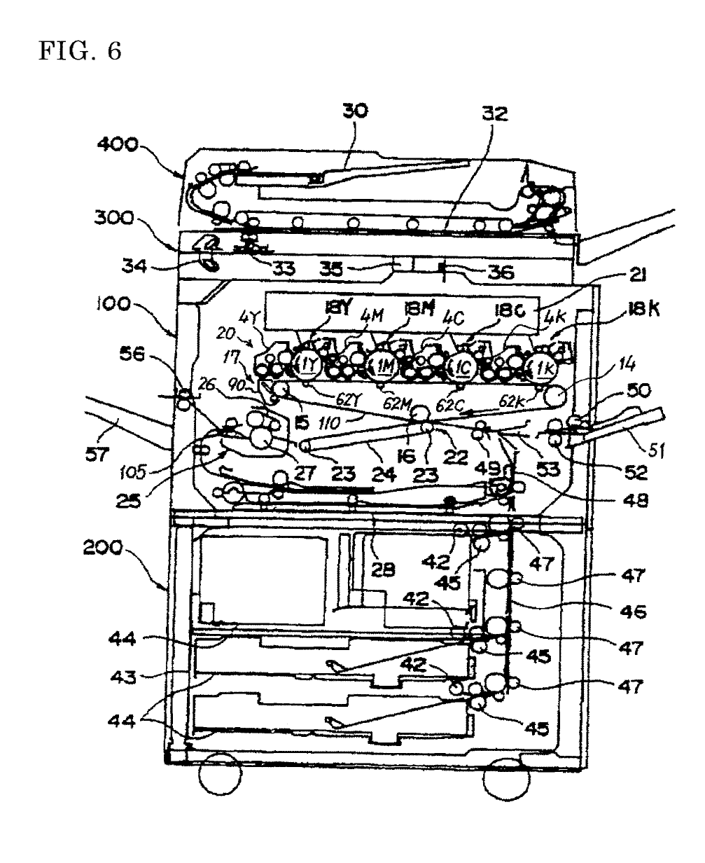

FIG. 6 is a schematic construction view that exemplarily shows a copier of an inventive embodiment. The copier is equipped with an apparatus body 100, a paper feed device 200 on which the apparatus body 100 being disposed, and a scanner 300 that is fixed on the apparatus body 100, and also an automatic manuscript feed device 400 that is fixed on the scanner 300.

The apparatus body 100 is equipped with an image forming unit 20, having process cartridges 18Y, 18M, 18C, and 18K, to form images of yellow (Y), magenta (M), cyan (C), and black (B) colors. The marks of Y, M, C, and K after reference numbers indicate their application for yellow, magenta, cyan, and black (similarly in the following). In addition to the process cartridges 18Y, 18M, 18C, and 18K, the apparatus body 100 is equipped with a light writing unit 21, an intermediate transfer unit 17, a secondary transfer device 22, a resist roller pair 49, and a fixing device 25 of belt fixing type.

The light writing unit 21 has a light source (not shown), polygon mirror, and fθ lens, and irradiates a laser light on the surface of the photoconductor described later on the basis of image data.

The process cartridges 18Y, 18M, 18C, and 18K are equipped with drum photoconductors 1Y, 1M, 1C, and 1K, charging devices, developing devices 4Y, 4M, 4C, and 4K, drum cleaning devices, charge eliminating devices, etc.

The process cartridge 18Y for yellow will be explained in the following.

The surface of the photoconductor 1Y is uniformly charged by a charging device of a charging unit. The surface of the photoconductor 1Y, which being charge-treated, is irradiated a laser light that is modified and deflected by the light writing unit 21, then the electrical potential is decayed at irradiating or exposing portions. The decay may result in formation of an electrostatic latent image for yellow at the surface of the photoconductor 1Y. The resulting electrostatic latent image for yellow is developed by the developing device 4Y of a developing unit to form a Y toner image.

The Y toner image, formed on the photoconductor 1Y for yellow, is primarily transferred on the intermediate transfer belt 110 described later. The surface of the photoconductor 1Y is cleaned for transfer residual toner after the primary transfer by a drum cleaning device.

The photoconductor 1Y after cleaning by the drum cleaning device is charge-eliminated by a charge-eliminating device in the process cartridge 18Y for yellow, then is uniformly charged by the charging device to return to the initial condition. The series of processes described above are similar with the other process cartridges (18M, 18C, 18K).

The intermediate transfer unit will be explained in the following.

The intermediate transfer unit 17 is equipped with an intermediate transfer belt 110, belt cleaning device 90, etc., and also tension roller 14, drive roller 15, secondary transfer backup roller 16, and four primary transfer bias rollers 62Y, 62M, 62C, and 62K.

The intermediate transfer belt 110 is stretched under tension by plural rollers including a tension roller 14, and is endlessly transported clockwise in FIG. 6 by means of rotation of a drive roller 15 driven by a belt drive motor (not shown).

The four primary transfer bias rollers 62Y, 62M, 62C, and 62K are respectively disposed to contact with the inner circumferential side of the intermediate transfer belt 110, and are applied a primary transfer bias from a power supply (not shown), and also each presses the intermediate transfer belt 110 from the inner circumferential side to the photoconductors 1Y, 1M, 1C, and 1K to form a primary transfer nip. A primary transfer electric field is formed between the photoconductors and the primary transfer bias rollers at the respective primary transfer nips by influence of the primary transfer bias.

The Y toner image formed on the photoconductor 1Y for yellow is primarily transferred on the intermediate transfer belt 110 by action of the primary transfer electric field and the nip pressure. M, C, and K toner images formed on the photoconductors 1M, 1C, and 1K for M, C, and K are superposed in sequence to transfer primarily on the Y toner image. The primary transfer through the superposition may form a four color superposed toner image (hereinafter referred to as “four color toner image”) of multiple toner image on the intermediate transfer belt 110.

The four color toner image, superposed and transferred on the intermediate transfer belt 110, is secondarily transferred on a transfer paper of recording sheet (not shown) at the secondary transfer nip described later. The transfer-residual toner remaining on the surface of the intermediate transfer belt 110 is cleaned by the belt cleaning device 90 that pinches a belt between the drive roller 15 at left side in FIG. 6.

The secondary transfer device 22 will be explained in the following.

The secondary transfer device 22, which stretches a paper conveying belt 24 by two tension rollers 23, is disposed below the intermediate transfer unit 17 in FIG. 6. The paper conveying belt 24 is endlessly conveyed anticlockwise in FIG. 6 along with rotational drive of at least one of tension rollers 23. One roller, disposed right side in FIG. 6 among the two tension rollers 23, pinches the intermediate transfer belt 110 and the paper conveying belt 24 between the secondary backup roller 16 of the intermediate transfer unit 17. The pinch forms a secondary transfer nip that contact the intermediate transfer belt 110 of the intermediate transfer unit 17 and the paper conveying belt 24 of the secondary transfer device 22. A secondary transfer bias of the polarity opposite to toner is applied to one tension roller 23 by a power supply (not shown). When the secondary transfer bias is applied, a secondary transfer electric field is formed at the secondary transfer nip that makes the four color toner image on the intermediate transfer belt 110 of the intermediate transfer unit 17 move electrostatically onto one of the tension roller 23. The four color toner image, which being affected by the secondary transfer electric field and the nip pressure, is secondarily transferred on the transfer paper that is fed to the secondary transfer nip so as to synchronize with the four color toner image on the intermediate transfer belt 110 by the resist roller pair 49 described later. A charger can be provided to charge the transfer paper in a non-contact manner instead of the secondary transfer system that applies the secondary transfer bias to one of the tension rollers 23 as described above.

Paper feed cassettes 44, capable of housing plural species of transfer papers each as paper bundle therein, are disposed vertically within the paper feed device 200 under the apparatus body 100 of the copier. Each of the paper feed cassettes 44 urges to contact the uppermost transfer paper of paper bundle to the paper feed roller 42, and the uppermost transfer paper is fed toward the paper feed path 46 by rotating the paper feed roller 42.

The paper feed path 46, which receives the transfer paper sent from the paper feed cassettes 44, has plural conveying roller pairs 47 and a resist roller pair 49 that is disposed near the end of the path, and conveys the transfer paper toward the resist roller pair 49. The transfer paper, conveyed toward the resist roller pair 49, is pinched between the rollers of the resist roller pair 49. On the other hand, the four color toner image, formed on the intermediate transfer belt 110 in the intermediate transfer unit 17, goes into the secondary transfer nip along with endless move of the belt. The resist roller pair 49 sends the transfer paper, pinched between rollers, at the timing capable of closely contacting with the four color toner image at the secondary transfer nip. Consequently, the four color toner image on the intermediate transfer belt 110 closely contacts with the transfer paper at the secondary transfer nip, and is secondarily transferred on the transfer paper to form a full color image on the white transfer paper. In this way, the transfer paper, on which the full color image being formed, is sent to a fixing device 25 from the paper conveying belt 24 after the secondary transfer nip along with the endless move of the paper conveying belt 24.

The fixing device 25 is equipped with a belt unit in which a fixing belt 26 is endlessly moved while being stretched by two rollers and a pressure roller 27 that is pressed toward one roller of the belt unit. The fixing belt 26 and the pressure roller 27 contact each other to form a fixing nip, and the transfer paper from the paper conveying belt 24 is pinched at the fixing nip. One roller, pushed from the pressure roller 27, among the two rollers of the belt unit is equipped with a heat source (not shown) therein, the fixing belt 26 is heated by the heat from the heat source. The heated fixing belt 26 heats the transfer paper pinched at the fixing nip. A full color image is fixed on the transfer paper by action of the heat and the nip pressure.

The transfer paper, on which the fixing treatment being applied in the fixing device 25, is stacked at a stack portion 57, which being outwardly attached to the left plate in FIG. 6 of the printer housing, or is returned to the secondary transfer nip described above to form a toner image on the other side.

When a manuscript (not shown) is copied, a bundle of manuscript sheets is set on a manuscript table 30 of an automatic manuscript feed device 400. When the manuscript is fixed at one side like books, the manuscript is set on a contact glass 32. Before the setting, the automatic manuscript feed device 400 is opened to the copier body, and the contact glass 32 of a scanner 300 is exposed.

Then one-side closed manuscript is pressed by the closed automatic manuscript feed device 400.

After setting the manuscript in this way, a copy start switch is pushed on, then the scanner 300 starts the action to read the manuscript. In this regard, when manuscript sheets are set on the automatic manuscript feed device 400, the manuscript sheets are automatically moved to the contact glass 32 by the automatic manuscript feed device 400 before the action to read the manuscript. In the action to read the manuscript, a first traveler 33 and a second traveler 34 start to travel, and a light source on the first traveler 33 irradiates a light. The reflected light from the manuscript face is reflected by a mirror within the second traveler 34, and passes through an imaging lens 35, then enters into a read sensor 36. The read sensor 36 constructs image information on the basis of the incident light.

Various devices within the process cartridges 18Y, 18M, 18C, and 18K, the intermediate transfer unit 17, the secondary transfer device 22, and the fixing device 25 start their actions along with the action to read the manuscript. On the basis of the image information constructed by the read sensor 36, a light writing unit 21 is then activated and controlled, Y, M, C, and K toner images are formed on the photoconductors 40Y, 40M, 40C, and 40K. These toner images are superposed and transferred on the intermediate transfer belt 110 to form a four color image.

The action to feed paper starts within the paper feed device 200 approximately at the same time to start the action to read the manuscript. In the action to feed paper, one of paper feed rollers 42 is selectively rotated, and a transfer paper is sent from one of paper feed cassettes 44 that are contained in multiple steps within a paper bank 43. The transfer paper, which being sent out, is separated one sheet by one sheet at a separating roller 45 and enters into a reverse paper feed path 46, then is conveyed toward the secondary transfer nip by the conveying roller pair 47. In some cases, paper may be fed from a hand feed tray 51 instead of feeding the paper from the paper feed cassettes 44. In such a case, a hand paper feed roller 50 is selectively rotated to send the transfer paper on the hand feed tray 51, then a separating roller 52 separates the transfer paper one sheet by one sheet to feed the paper to a hand feed paper path 53 of the apparatus body 100.

In the copier, when multicolor images are formed from toners of two or more colors, the intermediate transfer belt 110 is stretched in a condition that the upper stretched face is approximately horizontal, thereby all of the photoconductors 1Y, 1M, 1C, and 1K are made contact with the upper stretched face. On the other hand, when monochrome images are formed merely from K toner, the intermediate transfer belt 110 is inclined to lower left in FIG. 6 by a mechanism (not shown), and he upper stretched face is separated from the photoconductors 1Y, 1M, and 1C for Y, M, and C. Then only the photoconductor 1K for K, among the four photoconductors 1Y, 1M, 1C, and 1K, is rotated anticlockwise in FIG. 6 thereby to form K toner images. At this time, developing devices are stopped for Y, M, and C in addition to the photoconductors, thereby to prevent unnecessary consumption of photoconductors and developers.

The copier is equipped with a control portion (not shown) that is constructed from CPU etc. to control devices described later in the copier and a control display portion (not shown) that is constructed from liquid crystal displays and various key buttons etc. Operators send a command to the control portion through processing key input to the control display portion, thereby one mode can be selected from three modes as to one-side print mode to form image on one side of transfer paper. The three one-side print modes consist of direct discharge mode, reverse discharge mode, and reverse decal discharge mode.

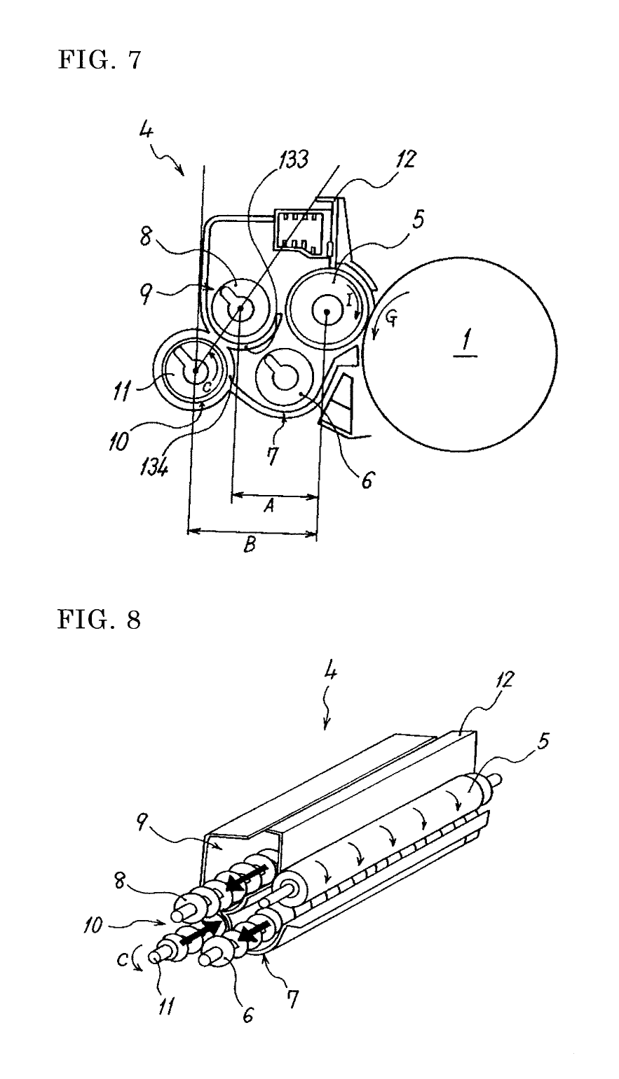

FIG. 7 is an enlarged view of the construction of a developing device 4 and a photoconductor 1 that are equipped by one of the four process cartridges 18Y, 18M, 18C, and 18K. The four process cartridges 18Y, 18M, 18C, and 18K has a similar construction except for the toner color, therefore, the additional characters Y, M, C, and K to be added to “4” are omitted.

The photoconductor 1 is charged for the surface by a charging device (not shown) while being rotated toward the arrow G as shown in FIG. 7. The surface of the charged photoconductor (1) is irradiated with a laser light from an exposing device (not shown) to form an electrostatic latent image, then a toner is supplied from a developing device 4 to form a toner image.

The developing device 4 supplies a toner to the latent image on the surface of the photoconductor 1 while moving along the surface in the direction of arrow I as shown in FIG. 7, and have a developing roller 5 as a developer bearing member and also a supplying screw 8 as a developer supplying conveying member that conveys the developer to the back side of FIG. 7 while supplying the developer to the developing roller 5.

A developer doctor 12 is provided as a developer control member to control the developer supplied to the developing roller 5 into a thickness appropriate to develop, at downstream side of the surface-moving direction from the opposing potion between the developing roller 5 and the supplying screw 8.

A collecting screw 6 is provided as a developer collecting conveying member to collect the developer passed through the developing portion after development and to convey the collected developer toward the same direction as the supplying screw 8, at downstream side of the surface-moving direction from the opposing potion of developing portion between the developing roller 5 and the photoconductor 1. A supplying conveying path 9, which being a developer supplying conveying path equipped with the supplying screw 8, is disposed in a transverse direction of the developing roller 5, and a collecting conveying path 7, which being a developer collecting conveying path equipped with the collecting screw 6, is disposed below the developing roller 5.

The developing device 4 is equipped with a stirring conveying path 10 of a developer stirring conveying path below the supplying conveying path 9 in parallel with the collecting conveying path 7. The stirring conveying path 10 is provided with a stirring screw 11 as a developer stirring conveying member that conveys the developer with stirring thereof into the front side of FIG. 7 in an opposite direction to the supplying screw 8.

The supplying conveying path 9 and the stirring conveying path 10 are partitioned by a first partition wall 133 of a partition member. The site of the first partition wall 133, where the supplying conveying path 9 and the stirring conveying path 10 being partitioned, is opened at both sides of front and back in FIG. 7, thus the supplying conveying path 9 and the stirring conveying path 10 are communicated each other.

The supplying conveying path 9 and the collecting conveying path 7 are also partitioned by the first partition member 133; however, no opening is provided at the site of the first partition wall 133 where the supplying conveying path 9 and the collecting conveying path 7 are partitioned.

The two conveying paths of the stirring conveying path 10 and the collecting conveying path 7 are partitioned by a second partition wall 134 of a partition member. The second partition wall 134 is opened at the front side of FIG. 7, thus the stirring conveying path 10 and the collecting conveying path 7 are communicated each other.

The supplying screw 8, the collecting screw 6, and the stirring screw 11 of the developer conveying member are each a resin screw; for example, all of the screws have a screw diameter of 18 mm Φ, a screw pitch of 25 mm, and a rotation number of about 600 rpm.

The development is carried out in a way that the developer, which being thin-layered on the developing roller 5 by a developing doctor 12 of stainless, is conveyed to the developing region that faces the photoconductor 1. The surface of the developing roller 5 is provided with V-grooves or treated with sand blast; for example, the construction is such that the gap of the developing doctor 12 and the photoconductor 1 is made into about 0.3 mm by use of an aluminum pipe of 25 mm Φ.

The developer is collected through the collecting conveying path 7 after development, conveyed to the front side of the cross section in FIG. 7, and transported into the stirring conveying path 10 at the opening of the first partition wall 133 provided at a non-image region. The toner is supplied into the stirring conveying path 10 from a toner supplying inlet, provided at upper of the stirring conveying path 10, around an opening of the first partition wall 133 at upstream side of developer conveying direction of the stirring conveying path 10.

Circulation of the developer within the three developer conveying paths will be explained in the following.

FIG. 8 is a perspective sectional view of the developing device 4 that explains the flow of developer in the developer conveying paths. The arrow marks in FIG. 8 indicate moving directions of developer.

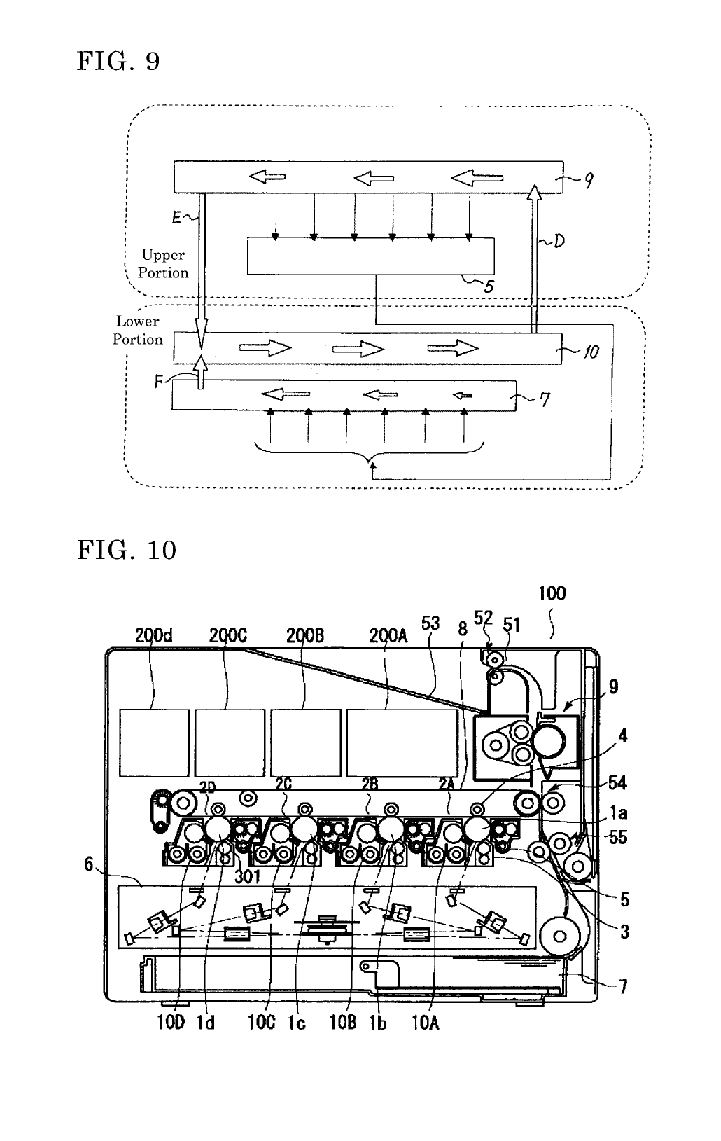

FIG. 9 is a pattern diagram that shows the flow of developer in a developing device 4, similarly as FIG. 8, the arrow marks in FIG. 9 indicate moving directions of developer.

The supplying conveying path 9, which receives the developer from the stirring conveying path 10, conveys the developer toward the downstream of the conveying direction of the supplying screw 8 while supplying the developer to the developing roller 5. Then the surplus developer, which being supplied to the developing roller 5 and conveyed to the downstream end of the supplying conveying path 9 in the conveying direction without being used for development, is supplied to the stirring conveying path 10 from the opening of the first partition wall 133 (arrow E in FIG. 9).

The collected developer, which being sent from the developing roller 5 to the collecting conveying path 7 and conveyed to the downstream end of the collecting conveying path 7 by the collecting screw 6, is supplied to the stirring conveying path 10 from the opening of the second partition wall 134 (arrow F in FIG. 9).

Then the supplied surplus developer and the collected developer are stirred and conveyed, through the stirring conveying path 10, to the downstream of conveying direction of the stirring screw 11 and the upstream of conveying direction of the supplying screw 8, and are supplied to the supplying conveying path 9 from the opening of the first partition wall 133 (arrow D in FIG. 9).

The collected developer, the surplus developer, and a toner supplied at a transporting portion as required are stirred and conveyed by the stirring screw 11 of the stirring conveying path 10 to the direction reverse to that of the developer within the collecting conveying path 7 and the supplying conveying path 9; then the stirred developer is transported to the upstream of the conveying direction of the supplying conveying path 9 that communicates at downstream side of the conveying direction. A toner concentration sensor (not shown) is provided below the stirring conveying path 10, and a toner supplying control device (not shown) is operated by a sensor output and then the toner is supplied from a toner container (not shown).

The developing device shown in FIG. 9 is equipped with the supplying conveying path 9 and the collecting conveying path 7 and the supply and the collection of developer are carried out at different developer conveying paths, therefore, the developer after developing is far from inclusion into the supplying conveying path 9. Accordingly, decrease of toner concentration can be prevented in the developer that is supplied to the developing roller 5 at the downstream of conveying direction of the supplying conveying path 9. In addition, the collecting conveying path 7 and the stirring conveying path 10 are equipped and the collection and the stirring of developer are carried out at different developer conveying paths, therefore, the developer after developing is far from drop during the stirring. Accordingly, sufficiently stirred developer is supplied to the supplying conveying path 9, thus the developer supplied to the supplying conveying path 9 can be prevented from insufficient stirring. Consequently, decrease of toner concentration can be prevented in the developer within the supplying conveying path 9 and insufficient stirring can be prevented in the developer within the supplying conveying path 9, as a result, image density can be made constant during developing.

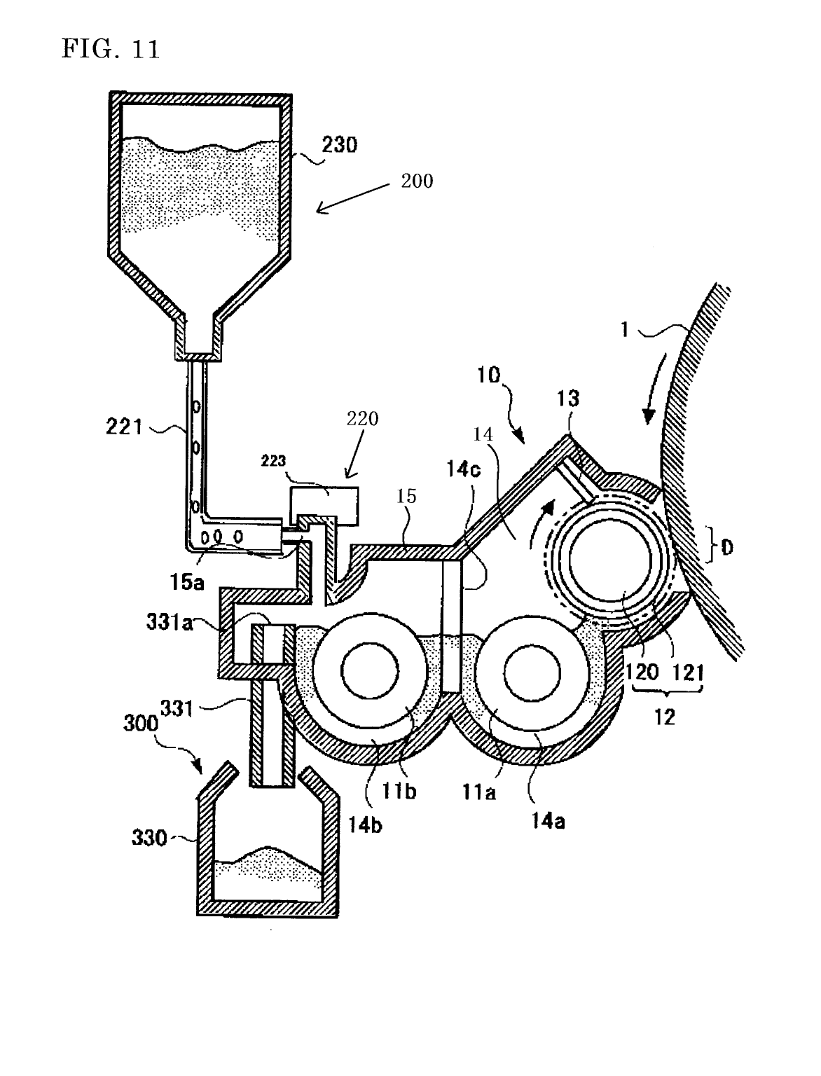

In this embodiment, the carrier described above in detail (see FIG. 4) is housed, in which the first particle G1 and the second particle G2 are contained within the coating layer 27 that coats the surface of core material 26, within the developer container 230 (see FIG. 11). In the image forming apparatus 100, a supplying developer that contains the carrier is supplied into the developer containing portion 14 from the inside of the developer container 230.

The toner and the carrier, which being supplied within the developer containing portion 14, are mixed together with the toner and the carrier, which being contained initially, by the conveying screws 11a and 11b. The toners and the carriers, or the carriers each other contact strongly, thus the film scraping tends to occur at the carrier surface due to friction at this stage.

However, a part of the first particle G1 exists as a convex state to the coating layer 27 in the carrier that is contained in the inventive developer. Therefore, even when toners or other carrier particles contact with the coating layer 27 during stirring and mixing, the impulse is mitigated by action of the convex portion at the surface of the coating layer 27, as described above. Consequently, the possibility to generate the film scraping can be considerably reduced at the surface of the carrier. Furthermore, even when the film scraping generates, no color smear occurs since white conductive fine particle is employed as the resistivity control agent.

Furthermore, the spent component of the toner, which being adhered on the carrier surface at stirring, is scratched off by the first particle G1 that exists in a convex state, thus the occurrence of toner spent can be prevented. Still more, the strength of the coating layer is enhanced by the second particle G2, thus the film scraping is unlikely to occur indeed. Therefore, the developer within the developer containing portion 14 can maintain the charge control effect more stably for a long period.

When development is carried out, as this embodiment, while the toner and the carrier are supplied into the developing device and the developer is discharged that comes to surplus within the developing device, the toner and the carrier may exist in a mixed condition from before supplying into the developing device and the toner and the carrier may be stored for a long period depending on the way of users. In addition, the toner and the carrier are supplied from the developer containing portion into the developing device in a mixed condition, thus the toner and the carrier are conveyed while contacting even within conveying paths. During these stages, the friction between the toner and the carrier, carriers themselves, or the carrier and the inner wall of conveying paths is weaker than the friction within the developing device, thus the film scraping is unlikely to occur in a level to alter the carrier properties described above. Therefore, the friction at these stages in the developing systems is far from a demerit to the carrier lifetime.

However, even when the level is less than those to alter the carrier properties, slight detachment of the surface layer of the coating layer may occur under prolonged contact and/or slight friction, and the detachment may cause color smear through mixing color with toners in cases where the detached coating layer contains a colored ingredient such as carbon black.

The present inventors have focused attention on the problem of color smear that is specific for the developing processes, as described above, and have found that when white particles are employed as the conductive material, the occurrence of color smear can be suppressed even in the processes where development is carried out while the toner and the carrier are supplied into the developing device and the developer is discharged that comes to surplus within the developing device. The present inventors have confirmed that both of the color and the conductivity can be satisfied when the particle, to which the conductive coating layer containing tin dioxide and indium oxide being provided, is employed as the white conductive particle.

Most part of deteriorated carrier is discharged by a developer discharging device 330 in the developing device 10 (see FIG. 10). However, a part of the deteriorated carrier may possibly remain within the developer containing portion 14 for a long period. Furthermore, when the consumption amount is small in the image forming apparatus 100, the carrier may remain within the developer containing portion 14 for a long period due to the small amount to exchange the carrier within the developer containing portion 14.

In this embodiment, the carrier same as the carrier used for the supplying developer is also used for the developer in-developing device that is contained within the developer containing portion 14, before supplying the developer within the developer container 230. Therefore, the carrier deterioration can be suppressed in the developer containing portion 14 through a mechanism similar as that described above even when the developer exchanging amount is small or a part of the carrier contained initially remains without being discharged from the developer containing portion 14, and the charging property of the developer may maintain a stable condition during or after a prolonged usage.

FIG. 10 is a schematic view that shows the construction of the image forming apparatus of an inventive embodiment.

In the body of image forming apparatus 100, image forming units 2A, 2B, 2C, and 2D of process cartridges having four photoconductors 1 of image bearing members are detachably attached to the image forming apparatus 100 respectively. A transfer device 3 is disposed at around center of the image forming apparatus 100 in a way that a transfer belt 8 is mounted rotatably toward the direction of arrow A over plural rollers.

The photoconductors 1 are disposed to the respective image forming units 2A, 2B, 2C, and 2D to contact with the lower face of the transfer belt 15. Developing devices 10A, 10B, 10C, and 10D are disposed correspondingly to the image forming units 2A, 2B, 2C, and 2D; the colors of toners used in the developing devices 10A, 10B, 10C, and 10D are different each other.

The image forming units 2A, 2B, 2C, and 2D have an identical configuration; the image forming unit 2A forms images of magenta color, the image forming unit 2B forms images of cyan color, the image forming unit 2C forms images of yellow color, and the image forming unit 2D forms images of black color.

The developing devices 10A, 10B, 10C, and 10D, which being disposed respectively within the image forming units 2A, 2B, 2C, and 2D, use two-component developers containing toners and carriers, and employ such a system a toner is supplied from the developer supplying device 200 described above, depending on the output of a toner concentration sensor (not shown) equipped at the developer containing portion 14, and also a carrier is supplied to discharge the previous developer thus the developer can be exchanged.

Developer supplying devices 200A, 200B, 200C, and 200D are disposed at the space above the image forming units 2A, 2B, 2C, and 2D. The developer supplying devices 200 have a construction to supply a fresh toner and a fresh carrier other than the toner to supply to the photoconductors 1, and the construction is shown in FIG. 11.

An exposing device 6 as a writing unit is disposed below the image forming units 2A, 2B, 2C, and 2D.

The exposing device 6 is constructed from four light sources of respective colors of laser diode (LD) system, a set of polygon scanner formed of a hexahedral polygon mirror and a polygon motor, and lenses and mirrors such as fθ lenses and long cylindrical lenses. The laser light, emitted from a laser diode, is polarized and scanned by a polygon scanner to irradiate the photoconductors 1.

A fixing device 9 is disposed between the transfer belt 8 and the developer supplying devices 200 to fix images transferred on a transfer paper. A paper discharging path 51 is formed at downstream of transfer paper conveying direction of the fixing unit 9, and the transfer paper is conveyed through the paper discharging path 51 and can be discharged on the discharging paper tray 53 by a charging paper roller pair 52.

A paper feeding cassette 7, capable of storing transfer paper, is disposed blow the image forming apparatus 100.

The image forming apparatus 100 will be explained in terms of the operation to form image in the following. When the operation starts to form images, the photoconductors 1 rotate clockwise in FIG. 10 respectively, and the surfaces of photoconductors 1 are uniformly charged by charging rollers of charging units 3. Then a laser light corresponding to a magenta image is irradiated to the photoconductor 1a of the image forming unit 2A from the exposing unit 6, a laser light corresponding to a cyan image is irradiated to the photoconductor 1b of the image forming unit 2B, a laser light corresponding to a yellow image is irradiated to the photoconductor 1c of the image forming unit 2C, and a laser light corresponding to a black image is irradiated to the photoconductor id of the image forming unit 2D, and latent images are respectively formed correspondingly to the image data of respective colors. When latent images teach the sites of developing devices 10A, 10B, 10C, and 10D respectively while the photoconductors 1 are rotated, the latent images are developed by magenta, cyan, yellow, and black toners to form a four color toner image.

On the other hand, a transfer paper is fed by a paper separating feeding portion from the paper feeding cassette 7, then the transfer paper is conveyed at a timing matching with the toner images formed on the photoconductors 1 by a resist roller pair 55 disposed immediately before the transfer belt 8. The transfer paper is charged in plus polarity by a paper absorbing roller 54 that is disposed near the inlet of the transfer belt 8, thereby is electrostatically adsorbed to the surface of the transfer belt 8. Then magenta, cyan, yellow, and black toner images are transferred on the transfer paper while being conveyed in a condition adsorbed to the transfer belt 8 to form a full color toner image having overlapped four colors. The toner image is melt and fixed by heating and pressing the transfer paper by use of the fixing device 9, then the transfer paper is discharged through a paper discharging system to a paper discharge tray 53 at upper of the image forming apparatus 1.

The construction around the developing device will be explained in the following. FIG. 11 is a schematic cross section that shows the configuration of the developing device equipped in the inventive image forming apparatus and surrounding thereof. In FIG. 11, a developer supplying device 200, which supplies a developer of a fresh toner and a fresh carrier into the developing device 10, is disposed above the developing device 10, and a developer discharging device 300, which discharges the developer that comes to residual in the developing device 10, is disposed below the developing device 10.

The main portion of the developing device 10 is constructed from a housing 15 that has a developer containing portion 14 that contains a two-component developer of a toner and a carrier, a developing roll 12 of a developer carrying conveying body that is disposed at an opening side of the housing 15 to rotate closely with the photoconductors 1 of image bearing members, two conveying screws 11a and 11b of a developer stirring conveying member that is disposed to rotate within the developer containing portion 14, and a layer thickness control member 13 that is disposed in a condition of pressing contact or nearly contact to the surface of the developing roller 12.

Among these, the developing roller 12 is a rotatable cylindrical sleeve 121 that has a magnet roll 120 fixed therein. The developer containing portion 14 is formed from container spaces 14a, 14b that are divided into two parts by a central partition 14c and are communicated through communicating portions at both sides; the developer is circulated and conveyed while being stirred between the container spaces 14a, 14b by conveying screws 11a, 11b that rotate respectively within the container spaces 14a, 14b. The layer thickness control member 13 has a double structure of a non-magnetic material and a magnetic material, and is disposed such that the top edge thereof faces a certain magnetic pole of the magnetic roll 120.

In the developing device 10, most part of deteriorated carrier is discharged by a developer discharging device 300. However, a part of the deteriorated carrier may possibly remain within the developer containing portion 14 for a long period; furthermore, when the consumption amount is small in the image forming apparatus, the carrier may remain within the developer containing portion 14 for a long period due to the small amount to exchange the carrier within the image forming apparatus.

In this embodiment, the carrier same as the carrier used for the supplying developer is also used for the developer in-developing device that is contained within the developer containing portion 14, before supplying the developer within the developer container 230. Therefore, the carrier deterioration can be suppressed in the developer containing portion 14 through a mechanism similar as that described above even when the developer exchanging amount is small or a part of the carrier contained initially remains without being discharged from the developer containing portion 14, and the charging property of the developer may maintain a stable condition during or after a prolonged usage.

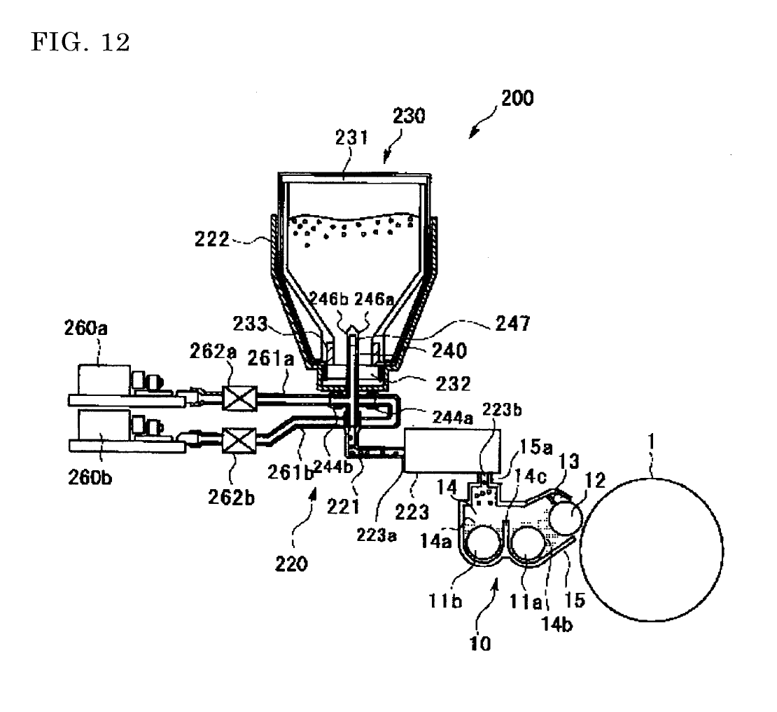

As shown in FIG. 12, the developer supplying device 200 is constructed from a developer container 230, which contains a two-component developer for supplying and a developer supplier 220 that sends and supplies the two-component developer within the developer container 230 to the developer containing portion 14. The developer supplier 220 is disposed between the developer container 230 and the developing device 10 connected thereto respectively.

The configuration of the developer supplying device 200 will be explained in detail later with reference to FIG. 12.

As shown in FIG. 11, the developer discharging device 300 is constructed from a collecting container 330 that collects the two-component developer that comes to residual within the developer containing portion 14 and a discharge pipe 331 of a developer discharging unit that sends the residual developer, overflowing from the developer containing portion 14, to the collecting container 330. The discharging pipe 331 is disposed such that the upper opening 331a is sited at a certain height within the developer containing portion 14, and the developer that goes over the upper opening 331a at the certain height is discharged.

The developer discharging device 300 is not defined to the construction described above, in the present invention; a developer outlet is opened at a certain site of the housing 15, a conveying member such as discharging screws is disposed as a developer discharging unit near the developer outlet in place of the discharging pipe 331, and the developer discharged from the developer outlet may be conveyed to the collecting container 330.

In this embodiment, the discharging crew may also be provided at edge or inside the discharging pipe 331.

The developing operation of the developing device will be explained in the following with reference to FIG. 11.

As shown in FIG. 11, the developer in-developing device, which being contained preliminarily within the developer containing portion 14, is initially stirred and mixed sufficiently by the conveying screws 11a and 11b and is further frictional-charged, then the developer is supplied to the developing roller 12 to adhere to the surface of sleeve 121 as a layer.

The developer, which adhering layer-like on the developing roller 12, is controlled by a layer thickness control member 13 into a uniform layer, then is conveyed to a developing region D where facing with the photoconductor 1 along with the rotation of sleeve 121. At the developing region D, the development is carried out in a way that a toner of two-component developer is electrostatically adsorbed onto a latent image formed on the photoconductor 1 depending on the image of manuscript at the body of the image forming apparatus 100, as shown in FIG. 10, thereby a toner image is formed on the photoconductor 1. The toner image, formed on the photoconductor 1, is transferred on a recording paper at the body of the image forming apparatus 100, and is fixed to the recording paper at the fixing portion.

When the developing operation is repeated, the toner of the developer in-developing device at the developer containing portion 14 is decreased gradually, then the toner decrease is detected by the toner concentration sensor and the developer supplier 220 of the developer supplying device 200 is activated. Consequently, the supplying developer, containing a carrier and a toner, that is contained within the developer containing member 231 of the developer container 230 is supplied. The fresh two-component developer, which being supplied into the developer containing portion 14, is stirred by the conveying screws 11a, 11b within the developer containing portion 14 and is sufficiently mixed with the developer in-developing device that was contained before the supply.

The toner and also the carrier are supplied by way of feeding the supplying developer from the developer supplying device 200 into the developer containing portion 14, therefore, the amount of developer comes to excessive gradually within the developer containing portion 14. The two-component developer, which coming to excessive within the developer containing portion 14, overflows beyond the defined height of the developer containing portion 14, and is contained within the collecting container 330 through the discharging pipe 331 of the developer discharging device 300.

The supplying developer is one that contains at least a toner and a carrier, in the present invention. The toner, described later, is available for the supplying developer that is contained within the developer container 230, and the magnetic carrier, which has the core material 26 and the coating layer 27 with a certain particle as shown in FIG. 4, is available for the carrier.

The toner of developer in-developing device may be the same or different with the toner within the developer container 230, and the carrier may also be the same or different with the carrier within the developer container 230.

The image forming apparatus 100 of this embodiment is equipped with a developer supplying device 200 that fills the supplying developer into an easy-deformable developer-containing member 231 and supplies to the developing device 10 through absorbing the supplying developer by a screw pump 223.

The construction of the developer supplying device 200 will be explained in more detail with reference to FIGS. 12 to 16 in the following.

FIG. 12 is a schematic view that shows the construction of the developer supplying device 200 available in the present invention. A developer containing member 231 as a volume-reducible bag member is equipped within the developer container 230 of the developer supplying device 200. The fresh supplying developer, which being supplied into the developer containing portion 14 of the developing device 10, is contained within the developer containing member 231. The developer containing member 231 reduces its volume when the inner pressure is reduced by supplying the developer into the developer containing portion 14.

The developer supplier 220 is equipped with a screw pump 223 that is disposed connectively at the upper end of a supplying inlet 15a opened at a certain site of the housing 15, a nozzle 240 that is disposed in connection with the screw pump 223, and air supplying units 260a and 260b that are disposed in connection with the nozzle 240; and the developer supplier 220 is driven in accordance with signals detected by the toner concentration sensor (not shown) that is disposed at the developer containing portion 14, and supplies an adequate amount of the developer from the developer container 230 to the developer containing portion 14.

A conveying tube 221 is disposed between the screw pump 223 and the nozzle 240 as a developer conveying path to connect to the screw pump 223. The conveying tube 221 is preferably made of flexible and excellently toner-resistant rubber material such as polyurethane, nitrile, and EPDM.

The developer supplying device 200 also has a container holder 222 to hold the developer container 230 as a developer storage container, and the container holder 222 is made of a highly rigid material such as resins.

The developer container 230 has a developer containing member 231 as a bag member formed of a flexible sheet material and a cap portion 232 as an outlet forming member to form a developer outlet.

The material of the developer containing member 231 is preferably one that provides a sufficient dimensional accuracy. Preferable examples of the material are resins such as polyester resins, polyethylene resins, polypropylene resins, polystyrene resins, polyvinyl chloride resins, polyacrylic acid, polycarbonate resins, ABC resins, and polyacetal resins.

A seal material 233 of sponge or rubber is provided at the cap portion 232, and a cross cut is provided in the seal material 233. When a nozzle 240 is passed through the nozzle 240 of the developer supplier 220, the developer container 230 and the developer supplier 220 are communicated and fixed.

In this embodiment, the cap portion 232 is disposed below the developer container 230. The condition of “cap portion 232 is disposed below” expresses that the cap portion 232 is disposed at a site having a downward vertical component of the developer container 230, in the condition that the developer container 230 is disposed at the developer supplying device 200.

The position of the cap portion 232, which being equipped at the body of the developer container, is not defined as described above; the cap portion 232 may be equipped at horizontal direction or inclined direction of the body of the developer container 230, in the condition that the developer container 230 is disposed at the developer supplying device 200.

The developer container may be exchanged sequentially to fresh ones depending on toner consumption; the developer container 230 of this embodiment allows easy attachment and detachment due to the constructions described above, and also toner leakage can be prevented at exchange and in use.

The developer containing member 231 may be properly selected with respect to its size, shape, structure, material, etc., without particular limitations.

The shape of the developer containing member 231 is preferably cylindrical, as described above, and preferably, spiral concavity and convexity are formed at the inner surface. When such concavity and convexity are formed, the toner contained within the containing member 231 can be smoothly moved toward the outlet side by way of rotating the developer container. It is also particularly preferable that a part or entire of the spiral portion exhibits an accordion performance.

The inventive developer container 230 can be easily attached and detached from the developer supplying device 200 of the image forming apparatus 100, and also is suited to storage and transportation, and provides excellent handleability.

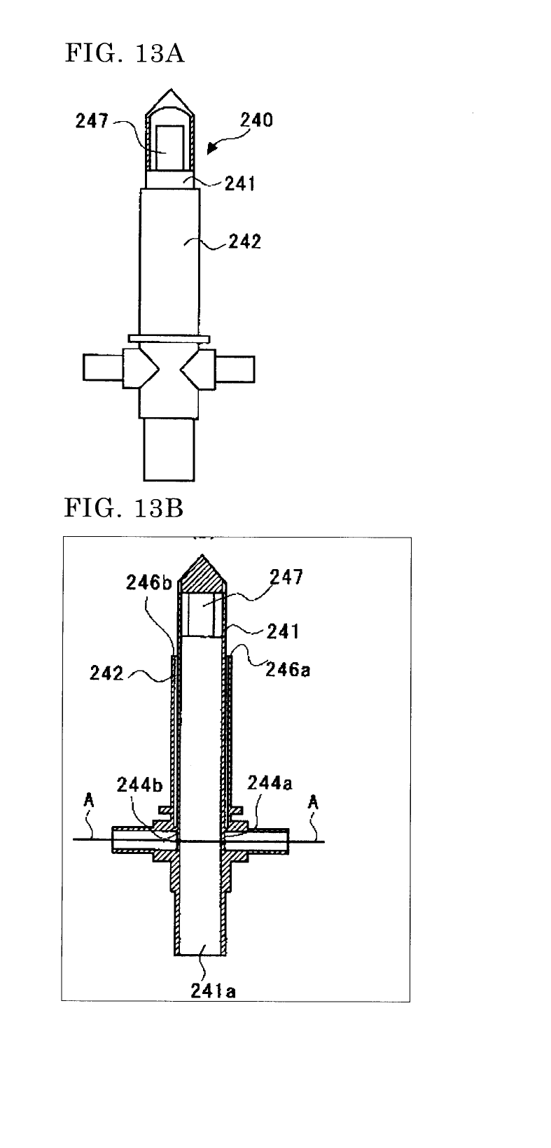

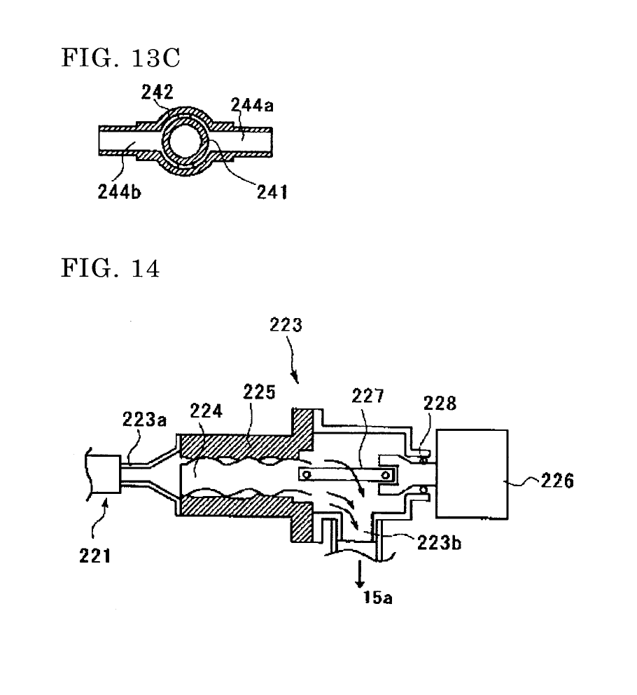

FIG. 13A is an outline view that shows schematically the construction of the nozzle 240 equipped in the developer supplier 220; FIG. 13B is a cross-section view in axial direction; FIG. 13C is a cross-section view at A-A in FIG. 13B. As shown in FIG. 13B, the nozzle 240 has a double pipe structure that has an inner pipe 241 and an outer pipe 242 that encapsulate the inner pipe 241. The inside of the inner pipe 241 is a developer flow path 241a as a developer conveying path to discharge the developer within the developer container 230. The toner within the developer container 230 is absorbed by an absorbing force induced by a screw pump 223, and is pulled into the screw pump 223 through the developer flow path 241a.

FIG. 14 is a cross-section view that shows schematically the construction of the screw pump 223. The screw pump 223, which being named as a uniaxial eccentric screw pump, has a rotor 224 and a stator 225 therein. The rotor 224, of which the circular cross section being spirally twisted, is formed of a hard material and engaged inside the stator 225. On the other hand, the stator 225 is formed of an elastic soft material with a hole having such as shape that oval cross section is spirally twisted, and the rotor 224 is engaged with the hole. The spiral pitch of the stator 225 is twice of the length of the spiral pitch of the rotor 224. The rotor 224 is connected to a drive motor 226, for rotationally driving the rotor 224, through a universal joint 227 and a bearing 228.

In this construction, the toner and the carrier, which being conveyed from the developer container 230 through the developer flow path 241a of the nozzle 240 and the conveying tube 221, enter into the screw pump 223 from the toner inlet 223a. Then the toner and the carrier enter into the space between the rotor 224 and the stator 225, then are absorbed and conveyed toward the right direction in FIG. 12 along with rotation of the rotor 224. Then the toner, which passes through the space between the rotor 224 and the stator 225, is fallen down from a toner outlet 223b, and is supplied into the developing device 10 through the developer supplying inlet 14 of the developing device 10.

In addition, the developer supplier 220 used in this embodiment is equipped with an air supplying units 260a, 260b that supply air into the developer container 230.

As shown in FIG. 12, the air flow paths 244a, 244b are connected to air pumps 260a, 260b as individual air feeding devices respectively, through air supplying paths 261a, 261b as air feeding ducts.

The air flow paths 244a, 244b are provided as air supplying paths, as shown in FIG. 13B, between the inner pipe 241 and the outer pipe 242 of the nozzle 240 of the developer supplier 220; the air path 44 is formed of two flow paths 244a, 244b that are independent and have a half-circle cross section, as shown in FIG. 13C.

The air pumps 260a, 260b may each be of conventional diaphragm type. The air fed out from the air pumps 260a, 260b are supplied into the toner container 230 from air inlets 246a, 246b as gas inlets of air flow paths through the air flow paths 244a, 244b. The air inlets 246a, 246b are placed downward the toner outlet 247 as the developer discharging outlet of the toner flow path 241a in FIG. 13B. Consequently, the air, supplied from the air inlets 246a, 246b is fed to the toner around the toner outlet 247, thus even when the toner represents a clogged condition because of standing for a long period without use, the toner clogging the toner outlet 247 can be broken down.

At the air supplying paths 261a, 261b, on-off valves 262a, 262b as an opening and closing unit are provided to open or close on the basis of control signal from a control portion of a gas feeding controlling unit (not shown). The on-off valves 262a, 262b open the valve to flow air when receiving on-signal from the control portion and close the valve to shut the air flow when receiving off-signal from the control portion.

The developer supplier 220 in this embodiment 100 will be explained in terms of the operation with reference of FIG. 12 in the following.

When the control portion receives from the developing device 10 a signal that the toner concentration is deficient, the operation to supply the developer is started. In the developer supplying operation, air pumps 260a, 260b are initially driven, air is fed into the developer container 230, and the developer is sucked and conveyed by driving the drive motor 226 of the screw pump 223 (see FIG. 14).

When the air pumps 260a, 260b send out air, the air flows into the air flow paths 244a, 244b of the nozzle 240 from the air supplying paths 261a, 261b, and flows into the developer container 230 from air inlets 246a, 246b. The developer within the developer container 230 is stirred by the air, and the fluidization is promoted since the developer has a condition involving much air therein.

When air is fed into the developer container 230, inner pressure increases within the developer container 230. Therefore, a pressure difference is created between the inner pressure and the outer pressure (atmosphere pressure) of the developer container 230, and a force acts to the fluidized developer to travel toward the direction of lower pressure. Consequently, the developer within the developer container 230 travels toward the direction of lower pressure i.e. flows out from the developer outlet 247.

In this embodiment, the absorbing force also acts by the screw pump 223, and the developer within the developer container 230 flows out from the developer outlet 247.

As described above, the developer, flowed out from the developer container 230, travels from the developer outlet 247 through the developer flow path 241a of the nozzle 240 (see FIG. 13B) and moves into the screw pump 223 through the conveying tube 221. Then the developer moves within the screw pump 223, and falls down from the developer outlet 223b, and the developer is supplied into the developing device 10 from the developer supplying inlet 15a. When a certain amount of the developer is supplied, the control portion stops the air pumps 260a, 260b and the drive motor 226, and closes on-off valves 262a, 262b, thereby the toner supplying operations are completed. As such, the toner within the toner container 230 is prevented from the adverse current to flow into the air pumps 260a, 260b through the air supplying paths 244a, 244b of the nozzle 240 by way of shutting the on-off valves 262a, 262b after completing the toner supplying operations.

The amount of air supplied from the air pumps 260a, 260b is set to be lower than the amount of toner and air sucked by the screw pump 223. Therefore, the inner pressure of the developer container 230 decreases as the toner is consumed. In this regard, the developer containing member 231 of the developer container 230 decreases its volume as the inner pressure decreases since being formed of a flexible sheet material in this embodiment.

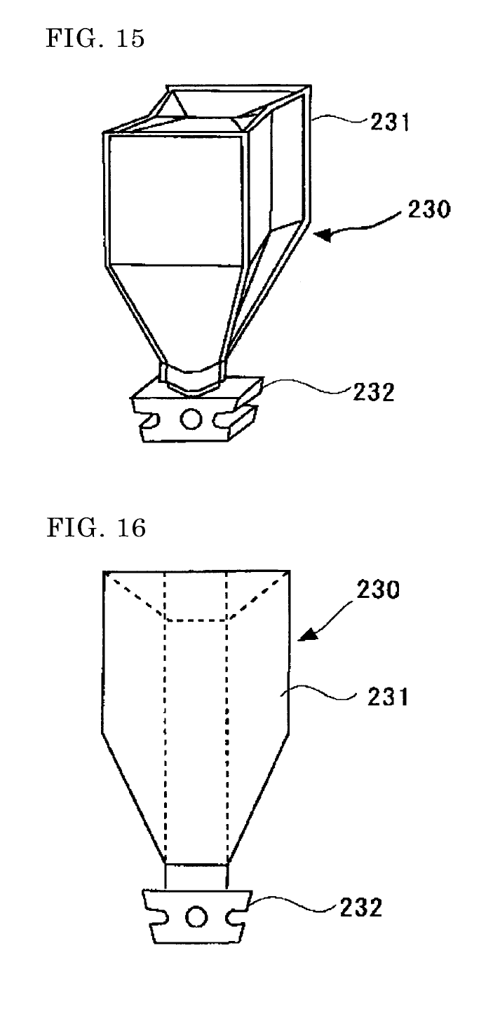

FIG. 15 is a perspective view that shows the condition where the developer is filled into the developer-containing member 231.

FIG. 16 is a front view that shows the condition where the developer within the developer-containing member 231 is discharged and the volume of the developer-containing member 231 is decreased or shrunk. It is preferred that the volume of the developer-containing member 231 can be decreased or shrunk in a rate of 60% or more.

The supplying developer of a toner and a carrier is contained within the developer-containing member 231 of the developer container 230 shown in FIG. 15 in order to supply the developing device 10 as described above.

It is preferred that the content of the carrier is 3% by mass or more and less than 30% by mass in the supplying developer.

When the content of the carrier is less than 3% by mass in the supplying developer within the developer container 230, the supplying effect is insufficient because of very small amount of the supplied carrier. On the other hand, when the content is above 30% by mass, the supplying developer may be difficult to supply stably into the developer containing portion.

The supplying toner and the toner of developer in-developing device are prepared to contain at least a binder, a colorant, and optional other ingredients such as release agent and charge control agent as required.

The method to produce the toner may be properly selected depending on the application without particular limitations; examples of the method include milling processes; suspension polymerization processes, emulsion polymerization processes, and polymer suspension processes where an oil phase is suspended or agglomerated within an aqueous medium to form particles of base material.

The binder resin of the toner in the present invention may be properly selected from conventional ones depending on the application without particular limitations; examples thereof include homopolymers of styrene or its substituted derivatives such as polystyrene, poly-p-styrene, and polyvinyltoluene; styrene copolymers such as styrene-p-chlorostyrene copolymers, styrene-propylene copolymers, styrene-vinyltoluene copolymers, styrene-methylacrylate copolymers, styrene-ethylacrylate copolymers, styrene-methacrylic acid copolymers, styrene-methylmethacrylate copolymers, styrene-ethylmethacrylate copolymers, styrene-butylmethacrylate copolymers, styrene-alpha-chloro methylmethacrylate copolymers, styrene-acrylonitrile copolymers, styrene-vinylmethylether copolymers, styrene-vinylmethylketone copolymers, styrene-butadiene copolymers, styrene-isopropyl copolymers, and styrene-maleate copolymers; polymethylmethacrylate resins, polybutylmethacrylate resins, polyvinyl chloride resins, polyvinyl acetate resins, polyethylene resins, polyester resins, polyurethane resins, epoxy resins, polyvinylbutyral resins, polyacrylic acid resins, rosin resins, modified rosin resins, terpene resins, phenol resins, aliphatic hydrocarbon resins, aromatic hydrocarbon resins, and aromatic petroleum resins. These may be used alone or in combination.

The colorant may be selected from conventional dyes and pigments depending on the application; examples thereof include carbon black, nigrosine dyes, iron black, Naphthol Yellow S, Hansa Yellow (10G, 5G, G), cadmium yellow, yellow iron oxide, yellow ocher, chrome yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, anthracene yellow BGL, isoindolinone yellow, colcothar, red lead oxide, lead red, cadmium red, cadmium mercury red, antimony red, Permanent Red 4R, Para Red, Fire Red, parachlororthonitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, eosine lake, Rhodamine Lake B, Rhodamine Lake Y, Alizarine Lake, Thioindigo Red B, Thioindigo Maroon, Oil Red, quinacridone red, Pyrazolone Red, Polyazo Red, Chrome Vermilion, Benzidine Orange, Perynone Orange, Oil Orange, cobalt blue, cerulean blue, Alkali Blue Lake, Peacock Blue Lake, Victoria Blue Lake, metal-free phthalocyanine blue, Phthalocyanine Blue, Fast Sky Blue, Indanthrene Blue (RS, BC), indigo, ultramarine, Prussian blue, Anthraquinone Blue, Fast Violet B, Methyl Violet Lake, cobalt violet, manganese violet, dioxazine violet, Anthraquinone Violet, chrome green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc white, and lithopone. These may be used alone or in combination. The content of the toner is preferably 1% to 15% by mass in the colorant, more preferably 3% to 10% by mass.

The colorant may be combined with resins to form a masterbatch. Such resins may be properly selected depending on the application; examples thereof include polymers of styrene or substituted styrenes, styrene copolymers, polymethylmethacrylate resins, polybutylmethacrylate resins, polyvinyl chloride resins, polyvinyl acetate resins, polyethylene resins, polypropylene resins, polyester resins, epoxy resins, epoxy polyol resins, polyurethane resins, polyamide resins, polyvinyl butyral resins, polyacrylic acid resins, rosin, modified rosins, terpene resins, aliphatic hydrocarbon resins, alicyclic hydrocarbon resins, aromatic petroleum resins, chlorinated paraffin, paraffin, and the like. These may be used alone or in combination.

The release agent may be properly selected from conventional ones, and preferably is exemplified by waxes.

Examples of waxes include carbonyl group-containing waxes, polyolefin waxes, long-chain hydrocarbons, and the like. These may be used alone or in combination. Among these, carbonyl group-containing waxes are preferable.

Examples of the carbonyl group-containing wax include polyalkanoic acid esters, polyalkanol esters, polyalkanoic acid amides, polyalkyl amides, dialkyl ketones, and the like. Examples of the polyalkanoic esters include carnauba wax, montan wax, trimethylolpropane tribehenate, pentaerythritol tetrabehenate, pentaerythritol diacetate dibehenate, glycerin tribehenate, 1,18-octadecan diol distearate, and the like. Examples of the polyalkanol esters include trimellitic tristearate, distearyl maleate, and the like. Examples of the polyalkanoic acid amides include behenyl amide and the like. Examples of the polyalkyl amides include trimellitic acid tristearyl amide, and the like. Examples of the dialkyl ketones include distearyl ketone, and the like. Among these carbonyl group-containing waxes, the polyalkanoic acid esters are particularly preferable.

Examples of polyolefin wax include polyethylene wax, polypropylene wax, and the like.

Examples of long-chain hydrocarbon include paraffin wax, Sasol wax, and the like.

The melting point of the release agent may be properly selected depending on the application; preferably, the melting point is 40° C. to 160° C., more preferably 50° C. to 120° C., and most preferably 60° C. to 90° C.

When the melting point is below 40° C., the wax may adversely affect high-temperature storage stability; and when the melting point is above 160° C., it is liable to cause cold offset at fixing processes under lower temperatures.

The viscosity of the melted release agent, measured at the temperature of 20° C. higher than the melting point of the wax, is preferably 5 cps to 1000 cps, and more preferably 10 cps to 100 cps. In cases where the melt viscosity is less than 5 cps, releasing ability may be deteriorated, and when the melt viscosity is more than 1000 cps, the offset resistance and the low-temperature fixing ability may be improved insufficiently.

The content of the release agent in the toner may be properly selected depending on the application; preferably, the content is 1% to 40% by mass, and more preferably 3% to 30% by mass. When the content is more than 40% by mass, the toner flowability may be deteriorated.

The charge control agent may be properly selected from positive or negative charge control agents depending on the positive or negative charge to be charged on the photoconductor.

The negative charge control agent may be exemplified by resins or compounds having an electron donating group, azo dyes, and metal complexes of organic acids; specific examples thereof include Bontron (product name: S-31, S-32, S-34, S-36, S-37, S-39, S-40, S-44, E-81, E-82, E-84, E-86, E-88, A, 1-A, 2-A, 3-A) (by Orient Chemical Industries, Ltd.), Kayacharge (product name: N-1, N-2), Kayaset Black (product name: T-2, 004) (by Nippon Kayaku Co.), Eisen Spiron Black (T-37, T-77, T-95, TRH, TNS-2) (by Hodogaya Chemical Co.), and FCA-1001-N, FCA-1001-NB, FCA-1001-NZ (by Fujikurakasei Co.).

The positive charge control agent may be exemplified by basic compounds such as nigrosine dyes, cationic compounds such as quaternary ammonium salts, and metal salts of higher fatty acids; specific examples thereof include Bontron (product name: N-01, N-02, N-03, N-04, N-05, N-07, N-09, N-10, N-11, N-13, P-51, P-52, AFP-B) (by Orient Chemical Industries, Ltd.), TP-302, TP-415, TP-4040 (by Hodogaya Chemical Co.), Copy Blue PR, Copy Charge (product name: PX-VP-435, NX-VP-434) (by Hexist Inc.), FCA (product name: 201, 201-B-1, 201-B-2, 201-B-3, 201-PB, 201-PZ, 301) (by Fujikurakasei Co.), and PLZ (product name: 1001, 2001, 6001, 7001) (by Shikoku Chemicals Co.). These may be used alone or in combination.

The amount of the charge control agent may be properly selected depending on the toner production processes like species of binder resins and dispersion processes without particular limitations; preferably, the amount is 0.1 to 10 parts by mass based on 100 parts by mass of the binder resin, more preferably 0.2 to 5 parts by mass. When the amount is above 10 parts by mass, the charging ability of the toner may be excessively large, the effect of the charge control agent may be decayed, the electrostatic absorbing force may increase in relation to developing rollers, thus flowability of the developer may be degraded or image density may decrease, and when the amount is less than 0.1 parts by mass, charge rising property or charge amount may be insufficient, which may affect toner images.

The materials added to toner may be optionally inorganic fine particles, flowability improvers, cleaning ability improvers, magnetic materials, metal soaps, etc. in addition to the binder resins, release agents, colorants, and charge control agents as required.

Examples of the inorganic fine particles may be silica, titania, alumina, cerium oxide, strontium titanate, calcium carbonate, magnesium carbonate, and calcium phosphate; more preferable are silica fine particles hydrophobic-treated with silicone oils or hexamethyldisilazane and titanium oxide surface-treated specifically.

The silica fine particles available in the present invention are, for example, Aerosil (product name: 130, 200V, 200CF, 300, 300CF, 380, OX50, TT600, MOX80, MOX170, COK84, RX200, RY200, R972, R974, R976, R805, R811, R812, T805, R202, VT222, RX170, RXC, RA200, RA200H, RA200HS, RM50, RY200, REA200) (by Nippon Aerosil Co.), HDK (product name: H20, H2000, H3004, H2000/4, H2050EP, H2015EP, H3050EP, KHD50), HVK2150 (by Wacker Chemical Co.), Cabosil (product name: L-90, LM-130, LM-150, M-5, PTG, MS-55, H-5, HS-5, EH-5, LM-150D, M-7D, MS-75D, TS-720, TS-610, TS-530) (Cabot Co.).

The amount of the inorganic fine particles is preferably 0.1 to 5.0 parts by mass based on 100 parts by mass of the toner base particle, more preferably 0.5 to 3.2 parts by mass.

The method to produce the inventive toner, which being unnecessary to be defined specifically, may be exemplified on the basis of milling processes as follows.

The materials of toner described above are mixed, and the mixture is melt and kneaded in a melting kneader. The melting kneader may be mono-axis or two-axis continuous kneaders or batch kneaders like roll mills; preferable examples thereof include KTK type two-axis extruder (by Kobe Steel, Ltd.), TEM type two-axis extruder (by Toshiba Machine Co.), two-axis extruder (by KCK Co.), PCM type two-axis extruder (by Ikegai Ltd.), and Co-kneader (by Buss Co.). It is preferred that the melting-kneading step is carried out under appropriate conditions far from cutoff of molecular chains in binder resins. Preferably, the melting-kneading temperature is adjusted referring to the softening point of the binder resin; when the temperature is excessively lower than the softening point, the cutoff will be significant, and excessively high temperature results in poor dispersion.

The kneaded product is milled after the step of melting-kneading. Preferably, the material is roughly milled then finely milled in the milling step. Preferable milling processes are exemplified by making the materials collide with a plate by means of jet air, making particles collide each other by means of jet air, or pulverizing by use of a narrow gap between mechanically rotating rotors and stators.

The milled product is classified into a particle having a predetermined particle diameter by a classifying step. The classification is carried out by way of removing fine particles using cyclones, decanters, centrifuge machines, etc.

After the milling and classifying steps, the milled product is classified within an air flow by use of centrifugal force, thereby to produce a toner having a predetermined particle diameter.

In addition, inorganic fine particles such as hydrophobic silica fine particle may be further added and mixed with the toner base particle produced as described above in order to enhance the flowability, storage stability, developing property, or transfer property of toner. The mixing of the additives described above may be carried out using conventional powder mixers; preferably, the mixer is equipped with jackets etc. to control the inner temperature. In order to alter the hysteresis applied to the additive, the additive may be added intermediately or gradually. In this case, rotation number, tumbling velocity, period, temperature, etc. of mixers may be changed; or initially higher load and then lower load may be applied, and vice versa. Examples of the available mixers include V-type mixers, Rocking mixers, Ledige mixers, Nauter mixers, and Henschel mixers. Then the mixture may be passed through a screen in order to remove coarse or fine particles thereby to obtain a toner.

In this embodiment, the developer, which containing the carrier and the toner described above, is used in the image forming apparatus shown in FIG. 10 as a developer for a supplying developer and a developer in-developing device, thereby, film scraping at carrier surface and/or toner spent at carrier surface are prevented to occur, decrease of charge amount of the developer and/or lowering of electrical resistance value of the carrier can be suppressed within the developer container 14, resulting in stable developing properties.

In the carrier used in this embodiment, the particle, which being provided with a conductive coating layer containing tin dioxide and indium oxide, is employed as the conductive particle, thereby, color smear can be prevented and also resistivity can be controlled effectively to lower; consequently, the resistivity can be adjusted without including carbon black which being a possible cause of color smear, and high quality color images can be formed with high color reproducibility and fineness, while maintaining stable charging ability without causing color smear on images even when used in color image forming apparatuses.

The construction of the image forming apparatus employed in the present invention is not limited the construction explained in terms of the inventive embodiments, that is, image forming apparatuses having other constitutions may be employed as long as having a similar performance.

### EXAMPLES

The present invention will be explained with reference to Examples and Comparative Examples, but the present invention should not be limited to Examples shown below. In the descriptions, all parts and percentages are expressed by mass unless indicated otherwise.

### Preparation of Toner

### Synthesis Example 1 of Binder Resin

Seven hundred and twenty-four parts of an adduct of bisphenol A with 2 moles of ethylene oxide, 276 parts of isophthalic acid, and 2 parts of dibutyltin oxide were poured into a reactor vessel equipped with a condenser, a stirrer and a nitrogen gas inlet, and the mixture was allowed to react at 230° C. for 8 hours under normal pressure, then was further allowed to react under a reduced pressure of 10 to 15 mmHg for 5 hours, followed by cooling to 160° C.; 32 parts of phthalic anhydride was then added to the reactant and the mixture was allowed to react for 2 hours.

The reactant was then cooled to 80° C., which was allowed to react with 188 parts of isophorone diisocyanate in ethyl acetate for 2 hours to prepare an isocyanate-containing prepolymer P1.

Then 267 parts of the prepolymer P1 and 14 parts of isophorone diamine were allowed to react at 50° C. for 2 hours, thereby to prepare a urea-modified polyester U1 having a mass average molecular mass of 64,000.

Similarly as described above, 724 parts of an adduct of bisphenol A with 2 moles of ethylene oxide and 276 parts of terephthalic acid were subjected to polycondensation at 230° C. for 8 hours under normal pressure, then was further allowed to react under a reduced pressure of 10 to 15 mmHg for 5 hours, thereby to prepare an unmodified polyester E1 having a peak molecular mass of 5,000.

The urea-modified polyester U1 of 200 parts and the unmodified polyester E1 of 800 parts were dissolved into 2,000 parts of a mixture solvent of ethyl acetate and MEK (1:1 of mass ratio) to prepare a solution of binder resin B1 in ethyl acetate and MEK.

A part of the solution was vacuum-dried to separate the binder resin B1, of which the Tg was 62° C.

### Synthesis Example of Polyester Resin A

| | |
|---|---|
| terephthalic acid | 60 parts |
| dodecenyl succinic anhydride | 25 parts |
| trimellitic anhydride | 15 parts |
| bisphenol A (2,2) propylene oxide adduct | 70 parts |
| bisphenol A (2,2) ethylene oxide adduct | 50 parts |

The ingredients described above were poured into a 1-L four-necked round flask equipped with a thermometer, a stirrer, a condenser, and a nitrogen gas inlet. The flask was placed on a mantle heater, the flask was heated while nitrogen gas was introduced into the flask from the nitrogen gas inlet to maintain inactive atmosphere within the flask, then 0.05 g of dibutyltin oxide was added into the flask and the temperature was maintained at 200° C. to react the content to prepare a polyester A. The polyester A had a peak molecular mass of 4,200 and a glass transition temperature of 59.4° C.

### Preparation Example 1 of Master Batch

| | |
|---|---|
| pigment: C.I. Pigment Yellow 155 | 40 parts |
| binder resin: polyester resin A | 60 parts |
| water | 30 parts |

The ingredients described above were mixed in a Henschel mixer to prepare a mixture containing pigment agglomerate to which water being immersed. The mixture was kneaded for 45 minutes by twin rolls of which the surface temperature was set to be 130° C., then was milled by a pulvelizer into a size of about 1 mm Φ to prepare a master batch M1.

### Toner Production Example A

Into a beaker, 240 parts of the solution of the binder resin B1 in ethyl acetate and MEK, 20 parts of pentaerythritol tetrabehenate (melting point: 81° C., melt viscosity: 25 cps), and 8 parts of the master batch M1 were introduced, then the mixture was stirred at 60° C. and 12,000 rpm by a TK-type homomixer to dissolve and disperse uniformly to prepare a toner ingredient liquid.

Into a beaker, 706 parts of deionized water, 294 parts of hydroxyapatite 10% suspension (Supertite 10, by Nippon Chemical Industrial Co.), and 0.2 part of dodecylbenzene sodium sulfonate were added and dissolved uniformly to prepare a solution.

Then the solution was heated to 60° C. and the toner ingredient solution was poured into the beaker while stirring at 12,000 rpm for 10 minutes by a TK-type homomixer.

The mixture liquid was then shifted to a korben equipped with a stirrer and a thermometer, and was heated to 98° C. to remove the solvent, then filtered, rinsed, and dried, followed by air classification to prepare a toner particle.

Then 1.0 part of hydrophobic silica and 1.0 part of hydrophobized titanium oxide were mixed to 100 parts of the toner particle in a Henschel mixer to prepare a toner A.

An ultra-thin segment of the toner A was prepared and the cross section of the toner was taken picture (magnification: 100,000×) by a transmission electron microscopy (H-9000H, by Hitachi Co.), and average values were obtained from variance diameters at colorant portions of randomly selected 100 sites on the photography. The variance diameter of one particle means the average of the longest diameter and the shortest diameter, and agglomerate itself was considered as one particle in case of representing agglomerate.

The average variance diameter of the colorant was 0.40 μm. The rate of the colorant having a variance diameter of no less than 0.7 μm was 4.5%.

The particle diameter of the toner A was measured by use of a particle analyzer of Coulter Counter TA2 (by Coulter Electronics Co.) at an aperture diameter of 100 μm, as a result, the volume average particle diameter Dv was 6.2 μm and the number average particle diameter Dn was 5.1 μm.

Next, the circularity of the toner A was measured in terms of average circularity by use of a flow-type particle image analyzer FPIA-1000 (by Sysmex Co.). The measurement was carried out in a way that 100 to 150 mL of pure water and 0.1 to 0.5 mL of a surfactant (alkylbenzene sulfonate) as a dispersant were put into the analyzer, then a sample was further added in an amount of 0.1 to 0.5 g, the mixture was dispersed for about 1 to 3 minutes by an ultrasonic disperser to prepare a measuring liquid of dispersion concentration of 3,000 to 10,000 particles/μL, and the measuring liquid was subjected to analyze. The circularity of the toner A was 0.96.

### Production Example of Conductive Fine Particle

### Production Example 1

One hundred grams of rutile type titanium dioxide (average primary particle diameter: 0.06 μm) was dispersed into 1 liter water to prepare an aqueous dispersion. The dispersion was heated and maintained at 70° C. Separately, a solution of 36.7 g of indium chloride InCl₃ and 5.4 g of tin (IV) chloride SnCl₄.5H₂O in 450 mL of 2N HCl, and 12% by mass aqueous ammonia were simultaneously dropped over about 1 hour so as to maintain pH of the suspension at 7 to 8. After the drop was completed, the suspension was filtered and rinsed, and the resulting cake of the pigment was dried at 110° C. Then the resulting dry powder was heated at 500° C. for 1 hour in a nitrogen gas flow (1 L/min) to obtain a white conductive fine particle “a”.

### Production Example 2

A carbon black (ketchen black EC600JD, by Lion Akzo Co.) itself was used as a conductive particle “b”.

### Production Example 3

One hundred grams of rutile type titanium dioxide (average primary particle diameter: 0.06 μm) was dispersed into 1 liter water to prepare an aqueous dispersion. The dispersion was heated and maintained at 70° C. Separately, a solution of 11.6 g of tin (IV) chloride SnCl₄.5H₂O in 100 mL of 2N HCl and 12% by mass aqueous ammonia were simultaneously dropped over about 40 minutes so as to maintain pH of the suspension at 7 to 8. Continuously and separately, a solution of 36.7 g of indium chloride InCl₃ and 5.4 g of tin (IV) chloride SnCl₄.5H₂O in 450 mL of 2N HCl, and 12% by mass aqueous ammonia were simultaneously dropped over about 1 hour so as to maintain pH of the suspension at 7 to 8. After the drop was completed, the suspension was filtered and rinsed, and the resulting cake of the pigment was dried at 110° C.

Then the resulting dry powder was heated at 500° C. for 1 hour in a nitrogen gas flow (1 L/min) to obtain a white conductive fine particle “c”.

### Production Example 4

A white conductive fine particle “d” was prepared in the same manner as Production Example 3 except that the base material was changed into aluminum oxide (average primary particle diameter: 0.07 μm).

### Production Example 5

A white conductive fine particle “e” was prepared in the same manner as Production Example 3 except that the base material was changed into aluminum oxide (average primary particle diameter: 0.35 μm).

### Production Example of Carrier

### Production Example 1

| | | |
|---|---|---|
| acrylic resin solution *¹⁾ | 2,130 | parts |
| aminosilane *²⁾ | 4 | parts |
| conductive fine particle “a” | 1,500 | parts |
| toluene | 6,000 | parts |

*¹⁾ solid content: 50% by mass
*²⁾ solid content: 100% by mass

The ingredients described above were dispersed for 10 minutes by a homomixer to prepare a liquid for forming resin layer. A ferrite particle having a volume average particle diameter of 35 μm was used as the core material of carrier, the resin solution described above was coated on the surface of the core material by use of Spira Coater (by Okada Seiko K. K.) under an atmosphere of 55° C. in a velocity of 30 g/min and dried so as to adjust the thickness “h” to 0.15 μm. The thickness of the layer was adjusted by the velocity of the liquid. The resulting carrier was calcined in an electric furnace at 150° C. for 1 hour, and was broken up using a screen of opening 100 μm after cooling, thereby to prepare a carrier I. The average thickness T was 0.20 μm.

The volume average particle diameter of the core material was carried out by Microtrack particle size distribution analyzer of SRA type (by Nikkiso Co.) at a range of 0.70 μm or larger and 125 μm or smaller.

The average thickness “h” (μm) of resin portion of the coating layer was determined through observing cross section of the carrier by use of a transmission electron microscope (TEM) and the thickness ha of resin portion between the surface of the core material and the particle, the thickness hb of resin portion between particles, and the thickness hc of resin portion on the core material or the particle were measured along the surface of the carrier in a pitch of 0.2 μm to take 50 measured values, then the measured values were averaged.

The thickness T (μm) of from the surface of the core material to the surface of the coating layer was determined through observing cross section of the carrier by use of a transmission electron microscope (TEM) and the thickness T of from the surface of the core material to the surface of the coating layer was measured along the surface of the carrier in a pitch of 0.2 μm to take 50 measured values, then the measured values were averaged.

### Production Example 2

A carrier II was produced in the same manner as Production Example 1 except that the conductive fine particle “b” was used for the conductive fine particle. The average thickness T was 0.21 μm.

### Production Example 3

| | | |
|---|---|---|
| acrylic resin solution *¹⁾ | 1,500 | parts |
| silicone resin solution *²⁾ | 1,575 | parts |
| aminosilane *³⁾ | 4 | parts |
| conductive fine particle “a” | 1,500 | parts |
| toluene | 6,000 | parts |

*¹⁾ solid content: 50% by mass
*²⁾ solid content: 20% by mass
*³⁾ solid content: 100% by mass

A carrier III was produced in the same manner as Production Example 1 except that the ingredients of the liquid for forming resin layer were changed into those described above. The average thickness T was 0.20 μm.

### Production Example 4

| | | |
|---|---|---|
| acrylic resin solution *¹⁾ | 1,500 | parts |
| guanamine solution *²⁾ | 450 | parts |
| aminosilane *³⁾ | 4 | parts |
| conductive fine particle “a” | 1,500 | parts |
| toluene | 6,000 | parts |

*¹⁾ solid content: 50% by mass
*²⁾ solid content: 70% by mass
*³⁾ solid content: 100% by mass

A carrier IV was produced in the same manner as Production Example 1 except that the ingredients of the liquid for forming resin layer were changed into those described above. The average thickness T was 0.20 μm.

### Production Example 5

A carrier V was produced in the same manner as Production Example 4 except that the conductive fine particle “c” was used for the conductive fine particle. The average thickness T was 0.20 μm.

### Production Example 6

A carrier VI was produced in the same manner as Production Example 4 except that the conductive fine particle “d” was used for the conductive fine particle. The average thickness T was 0.22 μm.

### Production Example 7

| | | |
|---|---|---|
| acrylic resin solution *¹⁾ | 1,500 | parts |
| guanamine solution *²⁾ | 450 | parts |
| aminosilane *³⁾ | 4 | parts |
| conductive fine particle “d” | 750 | parts |
| silica particle *⁴⁾ | 750 | parts |
| toluene | 6,000 | parts |

*¹⁾ solid content: 50% by mass
*²⁾ solid content: 70% by mass
*³⁾ solid content: 100% by mass
*⁴⁾ volume average particle diameter: 0.35 μm

A carrier VII was produced in the same manner as Production Example 1 except that the ingredients of the liquid for forming resin layer were changed into those described above. The average thickness T was 0.40 μm.

### Production Example 8

| | | |
|---|---|---|
| acrylic resin solution *¹⁾ | 1,500 | parts |
| guanamine solution *²⁾ | 450 | parts |
| aminosilane *³⁾ | 4 | parts |
| conductive fine particle “d” | 750 | parts |
| alumina particle *⁴⁾ | 750 | parts |
| toluene | 6,000 | parts |

*¹⁾ solid content: 50% by mass
*²⁾ solid content: 70% by mass
*³⁾ solid content: 100% by mass
*⁴⁾ volume average particle diameter: 0.37 μm

A carrier VIII was produced in the same manner as Production Example 1 except that the ingredients of the liquid for forming resin layer were changed into those described above. The average thickness T was 0.40 μm.

### Production Example 9

| | | |
|---|---|---|
| acrylic resin solution *¹⁾ | 1,500 | parts |
| guanamine solution *²⁾ | 450 | parts |
| aminosilane *³⁾ | 4 | parts |
| conductive fine particle “e” | 1,500 | parts |
| toluene | 6,000 | parts |

*¹⁾ solid content: 50% by mass
*²⁾ solid content: 70% by mass
*³⁾ solid content: 100% by mass

A carrier IX was produced in the same manner as Production Example 1 except that the ingredients of the liquid for forming resin layer were changed into those described above. The average thickness T was 0.40 μm.

### Production Example 10

| | | |
|---|---|---|
| acrylic resin solution *¹⁾ | 1,500 | parts |
| guanamine solution *²⁾ | 450 | parts |
| aminosilane *³⁾ | 4 | parts |
| conductive fine particle “e” | 750 | parts |
| alumina particle *⁴⁾ | 750 | parts |
| toluene | 6,000 | parts |

*¹⁾ solid content: 50% by mass
*²⁾ solid content: 70% by mass
*³⁾ solid content: 100% by mass
*⁴⁾ volume average particle diameter: 0.37 μm

A carrier X was produced in the same manner as Production Example 1 except that the ingredients of the liquid for forming resin layer were changed into those described above. The average thickness T was 0.40 μm.

### Production Example 11

| | | |
|---|---|---|
| acrylic resin solution *¹⁾ | 1,500 | parts |
| guanamine solution *²⁾ | 450 | parts |
| aminosilane *³⁾ | 4 | parts |
| conductive fine particle “e” | 750 | parts |
| alumina particle *⁴⁾ | 750 | parts |
| zinc oxide particle *⁵⁾ | 500 | parts |
| toluene | 6,000 | parts |

*¹⁾ solid content: 50% by mass
*²⁾ solid content: 70% by mass
*³⁾ solid content: 100% by mass
*⁴⁾ volume average particle diameter: 0.37 μm
*⁵⁾ volume average particle diameter: 0.020 μm

A carrier XI was produced in the same manner as Production Example 1 except that the ingredients of the liquid for forming resin layer were changed into those described above. The average thickness T was 0.42 μm.

### Production Example 12

| | | |
|---|---|---|
| acrylic resin solution *¹⁾ | 1,500 | parts |
| guanamine solution *²⁾ | 450 | parts |
| aminosilane *³⁾ | 4 | parts |
| conductive fine particle “e” | 750 | parts |
| alumina particle *⁴⁾ | 750 | parts |
| titanium oxide particle *⁵⁾ | 500 | parts |
| toluene | 6,000 | parts |

*¹⁾ solid content: 50% by mass
*²⁾ solid content: 70% by mass
*³⁾ solid content: 100% by mass
*⁴⁾ volume average particle diameter: 0.37 μm
*⁵⁾ volume average particle diameter: 0.015 μm

A carrier XII was produced in the same manner as Production Example 1 except that the ingredients of the liquid for forming resin layer were changed into those described above. The average thickness T was 0.41 μm.

### Production Example 13

A carrier XIII was produced in the same manner as Production Example 6 except that the coating amount was changed so as to adjust the thickness “h” to 0.05 μm. The average thickness T was 0.09 μm.

### Production Example 14

A carrier XIV was produced in the same manner as Production Example 12 except that the coating amount was changed so as to adjust the thickness “h” to 2.40 μm. The average thickness T was 0.09 μm.

### Example 1

Seven parts of the toner A obtained in Toner Production Example A and 93 parts of the carrier I obtained in Production Example 1 were mixed in a mixer for 10 minutes to prepare a developer for filling into a developing device. Eighty parts of the toner A obtained in Toner Production Example A and 20 parts of the carrier I obtained in Production Example 1 were mixed in a mixer for 10 minutes to prepare a supplying developer.

### Fineness of Image

The developing device shown in FIG. 11 was mounted on a commercially available digital full-color printer (imagio Neo C600, by Ricoh Co.), and a developer in-developing device and a supplying developer were set to a modified device that was mounted with the developing device shown in FIG. 14, then a character chart of image area 5% (size of one character: about 2 mm×2 mm) was output and the image fineness was evaluated from reproducibility of the character. The evaluation was four steps as follows.

A: very good

B: good

C: allowable

D: non-acceptable in practical use

### Durability

A running test for evaluating durability was carried out by way of outputting 100,000 sheets of the image for evaluating the image fineness described above. The durability was evaluated based on the decrease of charge amount and the change amount of carrier resistance.

The decrease of charge amount was determined in accordance with the following processes.

A sample, which being friction-charged by mixing 93% by mass of an initial carrier and 7% by mass of a toner, was measured for the charge amount by use of a conventional blow-off device (TB-200, by Kyocera Chemical Co.) and the charge amount was defined as the initial charge amount. Then the toner was removed from the developer after running by the blow-off device, and 93% by mass of the resulting carrier and 7% by mass of fresh toner was mixed and friction-charged in the same way as described above, then the charge amount was measured in the same way as the initial carrier, and the difference from the initial charge amount was defined as the decrease of charge amount. The target level of the decrease of charge amount is no more than 10.0 μC/g. The cause of the decrease of charge amount is toner spent on the carrier surface, therefore, the decrease of charge amount can be suppressed by decreasing the toner spent.

The change amount of carrier resistance was determined in accordance with the following processes.

A carrier was poured between parallel electrodes (gap: 2 mm) for resistance measurement and the resistance after applying DC 1,000 V for 30 seconds was measured by a high resist meter. The resulting value was converted to a volume resistivity, which was defined as the initial resistivity. Then the toner within the developer after running was removed by the blow-off device, the resulting carrier was measured for the resistance in the same manner as described above. The resulting value was converted to a volume resistivity, and the difference from the initial resistivity was defined as the change amount of carrier resistance. The target level of the change amount of carrier resistance is no more than 3.0 [Log(ohm·cm)] as absolute value.

The cause of the resistance change is scraping of the coating layer of carrier, spent of toner ingredient, detachment of larger particles in the coating layer of carrier, etc., thus the change of carrier resistance can be suppressed by lowering these factors.

### Carrier Adhesion on Background

The developing device shown in FIG. 11 was mounted on a commercially available digital full-color printer (imagio Neo C600, by Ricoh Co.), and a developer in-developing device and a supplying developer were set to a modified device that was mounted with the developing device shown in FIG. 7, then background potential was fixed to 150 V and a A3 character chart of image area 1% (size of one character: about 2 mm×2 mm) was output, and the number of occurrences of the carrier adhesion was measured at the background. The evaluation was four steps as follows.

A: 0

B: 2 or more and 5 or less

C: 6 or more and 10 or less

D: 11 or more

### Color Smear

A solid image was output and measured by X-Rite. Specifically, a developer was set, and the value E was obtained by measuring the image immediately after setting by use of X-Rite (X-Rite 938 D50, by Amtec Co.), the value E′ was obtained by measuring the image output after freely stirring for 1 hour at a developing unit itself by use of X-Rite, then ΔE was obtained from Equation (4) below, and the color smear was ranked as follows.

ΔE=E−E′ (4)
E=(L²+a*²+b*²)^{1/2}
(read value at Yellow ID=1.4)
E: initial E value
E′: after freely stirring for 1 hour

A: ΔE≦2

B: 2<ΔE≧5

C: 5<ΔE

### Nonuniformity of Image Density

A solid image was output after outputting 100,000 sheets of the image for evaluating the image fineness described above, and the nonuniformity of image density was visually evaluated to rank.

A: no nonuniformity on images

B: slightly observable nonuniformity of image density, no problematic

C: very noticeable nonuniformity of image density, no allowable

### Comparative Example 1

The evaluation was carried out in the same manner as that of Example 1 except that unmodified imagio Neo C600, which being mounted with the developer supplying device shown in FIG. 11, was used as the evaluation device, and the system was changed to one that supplies only a toner to the developing device without supplying and collecting the developer.

### Comparative Example 2

The evaluation was carried out in the same manner as that of Example 1 except that unmodified imagio Neo C600, which being mounted with the developer supplying device shown in FIG. 7, was used as the evaluation device, and the system was changed to one where the developer after development returns again to the developer supplying conveying path.

### Comparative Example 3, Examples 2 to 13

The evaluation was carried out in the same manner as that of Example 1 except that the carrier, used for the developer in-developing device and the supplying developer, was changed into the carriers prepared in Production Examples 2 to 14.

### Example 14

The evaluation was carried out in the same manner as that of Example 1 except that the supplying developer was prepared from 98 parts of the toner A obtained in Toner Production Example A and 2 parts of the carrier XII obtained in Production Example 12.

### Example 15

The evaluation was carried out in the same manner as that of Example 1 except that the supplying developer was prepared from 69 parts of the toner A obtained in Toner Production Example A and 31 parts of the carrier XII obtained in Production Example 12.

### Example 16

The evaluation was carried out in the same manner as that of Example 1 except that the developer in-developing device was prepared from 16 parts of the toner A obtained in Toner Production Example A and 84 parts of the carrier XII obtained in Production Example 12.

### Example 17

The evaluation was carried out in the same manner as that of Example 1 except that the developer in-developing device was prepared from 1 part of the toner A obtained in Toner Production Example A and 99 parts of the carrier XII obtained in Production Example 12.

The combinations of Examples 1 to 17 and Comparative Examples 1 to 3 are shown in Table 1, and the evaluation results are shown in Table 2.

TABLE 1

| | | | Average | | | | Second | | | Average |
|---|---|---|---|---|---|---|---|---|---|---|
| | | Conductive | Thickness | Hard | D1 | | Hard | D2 | | Thickness |
| | Carrier | Particle | h (μm) | Particle ¹*⁾ | (μm) | D1/h | Particle | (μm) | D1/h | T (μm) |
| Ex. 1 | I | a | 0.15 | — | 0.07 | 0.47 | — | — | — | 0.20 |
| Com. Ex. 1 | I | a | 0.15 | — | 0.07 | 0.47 | — | — | — | 0.20 |
| Com. Ex. 2 | I | a | 0.15 | — | 0.07 | 0.47 | — | — | — | 0.20 |
| Com. Ex. 3 | II | b | 0.15 | — | — | — | — | — | — | 0.21 |
| Ex. 2 | III | a | 0.15 | — | 0.07 | 0.47 | — | — | — | 0.20 |
| Ex. 3 | IV | a | 0.15 | — | 0.07 | 0.47 | — | — | — | 0.20 |
| Ex. 4 | V | c | 0.15 | — | 0.07 | 0.47 | — | — | — | 0.20 |
| Ex. 5 | VI | d | 0.15 | — | 0.08 | 0.53 | — | — | — | 0.22 |
| Ex. 6 | VII | d | 0.15 | silica | 0.35 | 2.33 | — | — | — | 0.40 |
| Ex. 7 | VIII | d | 0.15 | alumina | 0.37 | 2.47 | — | — | — | 0.40 |
| Ex. 8 | IX | e | 0.15 | — | 0.36 | 2.40 | — | — | — | 0.40 |
| Ex. 9 | X | e | 0.15 | alumina | 0.37 | 2.47 | — | — | — | 0.40 |
| Ex. 10 | XI | e | 0.15 | alumina | 0.37 | 2.47 | ZnO | 0.020 | 0.13 | 0.40 |
| Ex. 11 | XII | e | 0.15 | alumina | 0.37 | 2.47 | TiO | 0.015 | 0.10 | 0.40 |
| Ex. 12 | XIII | d | 0.05 | — | 0.08 | 1.60 | — | 0.015 | 0.30 | 0.09 |
| Ex. 13 | XIV | e | 2.4 | alumina | 0.37 | 0.15 | TiO | 0.015 | 0.01 | 3.03 |
| Ex. 14 | XII | e | 0.15 | alumina | 0.37 | 2.47 | TiO | 0.015 | 0.10 | 0.41 |
| Ex. 15 | XII | e | 0.15 | alumina | 0.37 | 2.47 | TiO | 0.015 | 0.10 | 0.41 |
| Ex. 16 | XII | e | 0.15 | alumina | 0.37 | 2.47 | TiO | 0.015 | 0.10 | 0.41 |
| Ex. 17 | XII | e | 0.15 | alumina | 0.37 | 2.47 | TiO | 0.015 | 0.10 | 0.41 |

¹*⁾ other than conductive particle, ZnO: zinc oxide, TiO: titanium oxide

TABLE 2

| | | Initial | Decreased | Volume | Changed | Carrier | | Nonuni- |
|---|---|---|---|---|---|---|---|---|
| | | Charge | Amount of | Resistivity | Amount of | Adhesion | | formity |
| | Image | Amount | Charge | log | Charge (μc/g) | at | Color | of image |
| | Fineness | (μc/g) | (μc/g) | [ohm · cm] | log [ohm · cm] | Background | Smear | density |
| Ex. 1 | C | 34 | 8.9 | 15.4 | 2.7 | C | A | A |
| Com. Ex. 1 | C | 34 | 15.5 | 15.4 | 4.0 | A | A | A |
| Com. Ex. 2 | C | 34 | 8.7 | 15.4 | 2.4 | C | A | C |
| Com. Ex. 3 | A | 26 | 9.7 | 12.7 | 2.6 | C | C | A |
| Ex. 2 | C | 34 | 8.6 | 15.3 | 2.2 | C | A | A |
| Ex. 3 | C | 34 | 8.4 | 15.3 | 2.1 | C | A | A |
| Ex. 4 | A | 25 | 8.2 | 13.0 | 1.8 | A | A | A |
| Ex. 5 | A | 25 | 8.0 | 12.9 | 1.7 | A | A | A |
| Ex. 6 | B | 30 | 6.0 | 14.9 | 1.6 | B | A | A |
| Ex. 7 | B | 31 | 5.6 | 15.0 | 1.6 | B | A | A |
| Ex. 8 | A | 25 | 4.5 | 13.2 | 1.5 | A | A | A |
| Ex. 9 | B | 31 | 4.5 | 15.2 | 1.5 | B | A | A |
| Ex. 10 | B | 30 | 4.3 | 14.7 | 1.1 | B | A | A |
| Ex. 11 | B | 29 | 4.2 | 14.4 | 0.9 | B | A | A |
| Ex. 12 | A | 24 | 8.5 | 12.1 | 2.7 | A | A | A |
| Ex. 13 | B | 32 | 4.1 | 15.5 | 1.0 | C | A | A |
| Ex. 14 | B | 29 | 9.6 | 14.4 | 2.5 | B | A | A |
| Ex. 15 | B | 29 | 5.2 | 14.4 | 1.9 | B | A | A |
| Ex. 16 | C | 29 | 8.3 | 14.4 | 2.4 | A | A | A |
| Ex. 17 | C | 29 | 4.6 | 14.4 | 2.7 | C | A | A |

The results of Tables 1, 2 demonstrate that color smear can be prevented and also carrier adhesion can be prevented from occurring at solid image portions even under usage for a long period, by way of employing particles, on which a conductive coating layer containing tin dioxide and indium oxide is provided, as the conductive particles at the coating layer of the core material of carrier and thus the resistivity can be adjusted even without carbon black that is a possible cause of the color smear.

What is claimed is:

1. A carrier for electrophotographic developer, comprising:
a particle of core material, and
a coating layer that coats the particle of core material,
wherein a toner and a carrier are supplied into a developing device where a toner and a carrier being contained, and the surplus developer within the developing device is discharged,
a coating layer on at least one of the supplied carrier and the carrier contained in the developing device comprises a white conductive fine particle that includes tin dioxide and indium oxide on a base material.

2. The carrier for electrophotographic developer according to claim 1, used for a developing device,
wherein the developing device comprises:
a developer bearing member that rotates while carrying a two-component developer of a magnetic carrier and a toner on its surface and supplies the toner to a latent image on the surface of a latent image bearing member at the site to face with the latent image bearing member to develop,
a developer supplying conveying path that is equipped with a developer supplying conveying member that conveys a developer along an axial direction of the developer bearing member and supplies the developer to the developer bearing member,
a developer collecting conveying path that is equipped with a developer collecting conveying member that conveys the developer, which being collected from on the developer bearing member after passing the site to face the latent image bearing member, along the axial direction of the developer bearing member and also along the same direction with that of the developer supplying conveying member,
a developer stirring conveying path that is equipped with a developer stirring conveying member that receives the surplus developer that is conveyed to the downmost-stream side of the conveying direction of the developer supplying conveying path without being used for development and the collected developer that is collected from the developer bearing member and is conveyed to the downmost-stream side of the conveying direction, and conveys the surplus developer and the collected developer while stirring them along the axial direction of the developer bearing member and also along the reverse direction with that of the developer supplying conveying member, and supplies the developer to the developer supplying conveying path, and
a partition member that partitions the three developer conveying paths of the developer collecting conveying path, the developer supplying conveying path, and the developer stirring conveying path therebetween,
wherein the height of the developer stirring conveying path and the height of the developer collecting conveying path are approximately the same, and the developer supplying conveying path is disposed higher than the other two developer conveying paths, and
the toner and the carrier are supplied into the developer conveying paths and the developer which being surplus in the developing device is discharged.

3. The carrier for electrophotographic developer according to claim 1, wherein the conductive coating layer of the white conductive fine particle is formed of a lower layer that includes tin dioxide and an upper layer that includes tin dioxide and indium oxide.

4. The carrier for electrophotographic developer according to claim 1, wherein the base material for the white conductive fine particle is aluminum oxide.

5. The carrier for electrophotographic developer according to claim 1, wherein the coating layer that coats the particle of core material of the carrier comprises a binder resin and at least one species of hard particle, and the ratio D1/h of the particle diameter D1 (μm) of the hard particle to the average thickness “h” (μm) of resin portion in the coating layer satisfies the relation of 1<D1/h<10.

6. The carrier for electrophotographic developer according to claim 5, wherein the hard particle is an alumina particle or an alumina-based particle.

7. The carrier for electrophotographic developer according to claim 5, wherein the white conductive fine particle is used for the hard particle.

8. The carrier for electrophotographic developer according to claim 5, wherein the coating layer that coats the particle of core material of the carrier comprises a second hard particle other than the hard particle, and the ratio D2/h of the particle diameter D2 (μm) of the second hard particle to the average thickness “h” (μm) of resin portion in the coating layer satisfies the relation of 0.001<D2/h<1.

9. The carrier for electrophotographic developer according to claim 8, wherein the second hard particle is a titanium oxide particle or a surface-treated titanium oxide particle.

10. The carrier for electrophotographic developer according to claim 1, wherein the average thickness T (μm) of from the surface of the particle of core material to the surface of the coating layer that coats the particle of core material is within a range of 0.1≦T≦3.0.

11. The carrier for electrophotographic developer according to claim 5, wherein the binder resin comprises at least one of a reaction product between an acrylic resin and an amino resin, and a silicone resin.

12. An image forming method, comprising developing an electrostatic latent image, which being formed on an image bearing member, while a toner and a carrier are supplied into a developing device, where a toner and a carrier being contained, and the surplus developer within the developing device is discharged,
wherein an electrophotographic developer that comprises a carrier and a toner is used in the image forming method,
the carrier is a carrier for electrophotographic developer that comprises a particle of core material and a coating layer that coats the particle of core material,
a toner and a carrier are supplied into a developing device where a toner and a carrier being contained, and the surplus developer within the developing device is discharged, and
a coating layer on at least one of the supplied carrier and the carrier contained in the developing device comprises a white conductive fine particle that includes tin dioxide and indium oxide on a base material.

13. A process cartridge, using an electrophotographic developer, comprising:
an image bearing member, and
a developing device that makes an electrostatic latent image formed on an image bearing member into a visible image by use of a developer that contains a toner and a carrier,
wherein the process cartridge is mounted detachably to a body of an image forming apparatus, and supports integratedly the image bearing member and the developing device,
the body of the image forming apparatus comprises a unit configured to supply the toner and the carrier to the developing device and a developer discharging unit configured to discharge the developer that comes to surplus within the developing device,
the electrophotographic developer contains a carrier and a toner,
the carrier is a carrier for electrophotographic developer that comprises a particle of core material and a coating layer that coats the particle of core material,
a toner and a carrier are supplied into a developing device where a toner and a carrier being contained, and the surplus developer within the developing device is discharged, and
a coating layer on at least one of the supplied carrier and the carrier contained in the developing device comprises a white conductive fine particle that includes tin dioxide and indium oxide on a base material.
